(19) United States
(12) Patent Application Publication
(10) Pub. No.: US 2015/0245062 A1
(43) Pub. Date: Aug. 27, 2015

(54) PICTURE ENCODING METHOD, PICTURE DECODING METHOD, PICTURE ENCODING APPARATUS, PICTURE DECODING APPARATUS, PICTURE ENCODING PROGRAM, PICTURE DECODING PROGRAM AND RECORDING MEDIUM

(71) Applicant: NIPPON TELEGRAPH AND TELEPHONE CORPORATION, Tokyo (JP)

(72) Inventors: Shinya Shimizu, Yokosuka-shi (JP); Shiori Sugimoto, Yokosuka-shi (JP); Hideaki Kimata, Yokosuka-shi (JP); Akira Kojima, Yokosuka-shi (JP)

(73) Assignee: NIPPON TELEGRAPH AND TELEPHONE CORPORATION, Tokyo (JP)

(21) Appl. No.: 14/430,492

(22) PCT Filed: Sep. 24, 2013
(86) PCT No.: PCT/JP2013/075753

§ 371 Date: Mar. 23, 2015

(30) Foreign Application Priority Data
Sep. 25, 2012 (JP) 2012-211155

(51) Int. Cl. H04N 19/597; H04N 19/52; H04N 19/577

(52) U.S. Cl. CPC H04N 19/597; H04N 19/577; H04N 19/52

(57) ABSTRACT

An picture encoding method includes steps of converting a reference depth map into a virtual depth map that is a depth map of an object photographed in a target picture, generating a depth value of an occlusion region in which there is no depth value in the reference depth map generated by an anteroposterior relationship of the object by assigning a depth value of which a correspondence relationship with a region on the same object as an object shielded in the reference picture is obtained to the occlusion region, and performing picture prediction between views by generating a disparity-compensated picture for the encoding target picture from the virtual depth map and the reference picture after the depth value of the occlusion region is generated.

### TECHNICAL FIELD

The present invention relates to a picture encoding method, a picture decoding method, a picture encoding apparatus, a picture decoding apparatus, a picture encoding program, a picture decoding program and a recording medium that encode and decode a multiview picture.

Priority is claimed on Japanese Patent Application No. 2012-211155, filed Sep. 25, 2012, the content of which is incorporated herein by reference.

### BACKGROUND ART

A multiview picture including a plurality of pictures obtained by photographing the same object and the same background using a plurality of cameras is conventionally known. This moving picture photographed using the plurality of cameras is referred to as a multiview moving picture (or a multiview video). In the following description, a picture (moving picture) captured by one camera is referred to as a “two-dimensional picture (moving picture)”, and a group of two-dimensional pictures (two-dimensional moving pictures) obtained by photographing the same object and the same background using a plurality of cameras differing in position and/or direction (hereinafter referred to as a view) is referred to as a “multiview picture (multiview moving picture).”

A two-dimensional moving picture has a strong correlation with respect to a time direction and coding efficiency can be improved by using the correlation. On the other hand, when cameras are synchronized with one another, frames (pictures) corresponding to the same time in videos of the cameras are those obtained by photographing an object and background in completely the same state from different positions, and thus there is a strong correlation between the cameras in a multiview picture and a multiview moving picture. It is possible to improve coding efficiency by using the correlation in coding of a multiview picture and a multiview moving picture.

Here, conventional technology relating to encoding technology of two-dimensional moving pictures will be described. In many conventional two-dimensional moving-picture coding schemes including H.264, MPEG-2, and MPEG-4, which are international coding standards, highly efficient encoding is performed by using technologies of motion-compensated prediction, orthogonal transform, quantization, and entropy encoding. For example, in H.264, encoding using a time correlation with a plurality of past or future frames is possible.

Details of the motion-compensated prediction technology used in H.264, for example, are disclosed in Non-Patent Document 1. An outline of the motion-compensated prediction technology used in H.264 will be described. The motion-compensated prediction of H.264 enables an encoding target frame to be divided into blocks of various sizes and enables each block to have a different motion vector and a different reference frame. Highly precise prediction which compensates for a different motion for a different object is realized by using a different motion vector for each block. On the other hand, high precise prediction considering occlusion caused by a temporal change is realized by using a different reference frame for each block.

Next, a conventional coding scheme for multiview pictures and multiview moving pictures will be described. A difference between a multiview picture encoding method and a multiview moving picture encoding method is that a correlation in the time direction and the correlation between the cameras are simultaneously present in a multiview moving picture. However, the same method using the correlation between the cameras can be used in both cases. Therefore, here, a method to be used in coding multiview moving pictures will be described.

In order to use the correlation between the cameras in the coding of multiview moving pictures, there is a conventional scheme of coding a multiview moving picture with high efficiency through “disparity-compensated prediction” in which motion-compensated prediction is applied to pictures captured by different cameras at the same time. Here, the disparity is a difference between positions at which the same portion on an object is present on picture planes of cameras arranged at different positions. FIG. 21 is a conceptual diagram of the disparity occurring between the cameras. In the conceptual diagram shown in FIG. 21, picture planes of cameras having parallel optical axes are looked down vertically. In this manner, the positions at which the same portion on the object is projected on the picture planes of the different cameras are generally referred to as correspondence points.

In the disparity-compensated prediction, each pixel value of the encoding target frame is predicted from a reference frame based on the correspondence relationship, and a predictive residue and disparity information representing the correspondence relationship are encoded. Because the disparity varies depending on a pair of target cameras and their positions, it is necessary to encode disparity information for each region in which the disparity-compensated prediction is performed. Actually, in the multiview coding scheme of H.264, a vector representing the disparity information is encoded for each block in which the disparity-compensated prediction is used.

The correspondence relationship obtained by the disparity information can be represented as a one-dimensional quantity indicating a three-dimensional position of an object, rather than a two-dimensional vector, based on epipolar geometric constraints by using camera parameters. Although there are various representations as information representing a three-dimensional position of an object, the distance from a reference camera to the object or coordinate values on an axis which is not parallel to the picture planes of the cameras is normally used. It is to be noted that the reciprocal of a distance may be used instead of the distance. In addition, because the reciprocal of the distance is information proportional to the disparity, two reference cameras may be set and a three-dimensional position of the object may be represented as a disparity amount between pictures captured by these cameras. Because there is no essential difference in a physical meaning regardless of what expression is used, information representing a three-dimensional position is hereinafter expressed as a depth without distinction of representation.

FIG. 22 is a conceptual diagram of the epipolar geometric constraints. According to the epipolar geometric constraints, a point on a picture of a certain camera corresponding to a point on a picture of another camera is constrained to a straight line called an epipolar line. At this time, when the depth of its pixel is obtained, the correspondence point is uniquely defined on the epipolar line. For example, as shown in FIG. 22, a correspondence point in a picture of a second camera picture for an object projected at a position m in a picture of a first camera is projected at a position m′ on the epipolar line when the position of the object in a real space is M′ and it is projected at a position m″ on the epipolar line when the position of the object in the real space is M″.

Non-Patent Document 2 uses this property and generates a highly precise predicted picture by synthesizing a predicted picture for an encoding target frame from a reference frame in accordance with three-dimensional information of each object given by a depth map (distance picture) for the reference frame, thereby realizing efficient multiview moving picture coding. It is to be noted that the predicted picture generated based on the depth is referred to as a view-synthesized picture, a view-interpolated picture, or a disparity-compensated picture.

Furthermore, in Patent Document 1, it is possible to generate a view-synthesized picture only for a necessary region by initially converting a depth map for a reference frame (a reference depth map) into a depth map for an encoding target frame (a virtual depth map) and obtaining a correspondence point using the converted depth map (the virtual depth map). Thereby, when a picture or moving picture is encoded or decoded while a method for generating a predicted picture is switched for each region of the encoding target frame or decoding target frame, a reduction in a processing amount for generating the view-synthesized picture and a reduction in a memory amount for temporarily storing the view-synthesized picture are realized.

### PRIOR ART DOCUMENTS

### Patent Document

### Patent Document 1:

Japanese Unexamined Patent Application, First Publication No. 2010-21844

### Non-Patent Documents

### Non-Patent Document 1:

ITU-T Recommendation H.264 (03/2009), “Advanced video coding for generic audiovisual services,” March, 2009.

### Non-Patent Document 2:

Shinya SHIMIZU, Masaki KITAHARA, Kazuto KAMIKURA and Yoshiyuki YASHIMA, “Multi-view Video Coding based on 3-D Warping with Depth Map,” In Proceedings of Picture Coding Symposium 2006, SS3-6, April, 2006.

### Non-Patent Document 3:

Y. Mori, N. Fukushima, T. Fujii, and M. Tanimoto, “View Generation with 3D Warping Using Depth Information for FTV,” In Proceedings of 3DTV-CON2008, pp. 229-232, May 2008.

### SUMMARY OF INVENTION

### Problems to be Solved by the Invention

With the method disclosed in Patent Document 1, it is possible to obtain a corresponding pixel on a reference frame from a pixel of an encoding target frame because a depth can be obtained for the encoding target frame. Thereby, when a view-synthesized picture is generated only for a specified region of the encoding target frame, it is possible to reduce the processing amount and the required memory amount by generating the view-synthesized picture for only a designated region of the encoding target frame compared to the case in which the view-synthesized picture of one frame is always generated.

However, in a method of synthesizing a depth map for the encoding target frame (virtual depth map) from the depth map for the reference frame (reference depth map), there is a problem in that depth information is not obtained for a region on the encoding target frame that is observable from a view at which the encoding target frame is captured, and cannot be observed from the view at which the reference frame is captured (hereinafter referred to as an occlusion region OCC), as shown in FIG. 11. FIG. 11 is an illustrative diagram showing a situation in which an occlusion region OCC is generated. This is because there is no corresponding depth information on the depth map for the reference frame. A view-synthesized picture cannot be generated when the depth information is not obtained.

Patent Document 1 provides a method of generating depth information for an occlusion region OCC by performing correction assuming continuity in a real space on a depth map (virtual depth map) for an encoding target frame obtained through conversion. In this case, since the occlusion region OCC is a region shielded by neighboring objects, a depth of a background object OBJ-B around the occlusion region or a depth smoothly connecting a foreground object OBJ-F and the background object OBJ-B is given as the depth of the occlusion region OCC in the correction assuming the continuity in the real space.

FIG. 13 shows a depth map when a depth of a neighboring background object OBJ-B is given to an occlusion region OCC (that is, when a depth is given to the occlusion region OCC on the assumption of continuity of the background object). In this case, a depth value of the background object OBJ-B is given as a depth value in the occlusion region OCC of the encoding target frame. Therefore, when a view-synthesized picture is generated using the generated virtual depth map, since the background object OBJ-B is shielded by the foreground object OBJ-F due to occlusion in the reference frame as shown in FIG. 19, a pixel on the occlusion region OCC is associated with a pixel on the foreground object OBJ-F on the reference frame, and the quality of the view-synthesized picture is degraded. FIG. 19 is an illustrative diagram showing a view-synthesized picture generated in an encoding target frame including the occlusion region OCC when the continuity of the background object is assumed in the occlusion region OCC.

On the other hand, FIG. 14 illustrates a depth map when a depth smoothly connecting the foreground object OBJ-F and the background object OBJ-B is given to the occlusion region OCC (that is, when the depth is given to the occlusion region OCC on the assumption of continuity of the object). In this case, a depth value continuously changing from a depth value indicating proximity to the view to a depth value indicating distance from the view is given as the depth value in the occlusion region OCC of the encoding target frame. When the view-synthesized picture is generated using such a virtual depth map, the pixel on the occlusion region OCC is associated between the pixel of the foreground object OBJ-F and the pixel of background object OBJ-B on the reference frame, as shown in FIG. 20. FIG. 20 is an illustrative diagram showing a view-synthesized picture generated in an encoding target frame including an occlusion region OCC in a situation in which a depth smoothly connecting a foreground object OBJ-F and a background object OBJ-B is given for the occlusion region OCC. A pixel value of the occlusion region OCC at this time is obtained by interpolating the pixel of the foreground object OBJ-F and the pixel of the background object OBJ-B. That is, the pixel of the occlusion region OCC has a value obtained by mixing the foreground object OBJ-F and the background object OBJ-B, and this is not a situation that basically occurs in practice. Accordingly, the quality of the view-synthesized picture is degraded.

The view-synthesized picture can be generated by performing an inpainting treatment on such an occlusion region using the view-synthesized picture obtained in the region around the occlusion region, as represented by Non-Patent Document 3. However, an effect of Patent Document 1 that a processing amount or a temporary memory amount can be reduced by generating a view-synthesized picture for only a specified region of the encoding target frame is not obtained since it is necessary to generate a view-synthesized picture even for a region around the occlusion region in order to perform an inpainting treatment.

The present invention has been made in light of such circumstances, and an object of the present invention is to provide an picture encoding method, an picture decoding method, an picture encoding apparatus, an picture decoding apparatus, an picture encoding program, an picture decoding program, and a recording medium in which high encoding efficiency and reduction of a memory capacity and a calculation amount can be realized while suppressing degradation of the quality of the view-synthesized picture when generating the view-synthesized picture of a target frame of an encoding process or decoding process using a depth map for a reference frame is obtained.

### Means for Solving the Problems

The present invention is a picture encoding method for performing encoding a multiview picture which includes pictures for a plurality of views while predicting a picture between the views using an encoded reference picture for a view different from a view of an encoding target picture and a reference depth map that is a depth map of an object in the reference picture, the method including: a depth map conversion step of converting the reference depth map into a virtual depth map that is a depth map of the object in the encoding target picture; an occlusion region depth generation step of generating a depth value of an occlusion region in which there is no depth value assigned in the reference depth map generated by an anteroposterior relationship of the object by assigning a depth value of which a correspondence relationship with a region on the same object as the object shielded in the reference picture is obtained to the occlusion region; and an inter-view picture prediction step of performing picture prediction between the views by generating a disparity-compensated picture for the encoding target picture from the virtual depth map and the reference picture after the depth value of the occlusion region is generated.

In the picture encoding method of the present invention, the occlusion region depth generation step may include generating the depth value of the occlusion region on an assumption of continuity of an object shielding the occlusion region on the reference depth map.

The picture encoding method of the present invention may further include: an occlusion generation pixel border determination step of determining a pixel border on the reference depth map corresponding to the occlusion region, wherein the occlusion region depth generation step may include generating the depth value of the occlusion region by converting a depth of an assumed object into a depth on the encoding target picture on an assumption that an object continuously exists from the same depth value as a depth value of a pixel having a depth value indicating proximity to the view to the same depth value as a depth value of a pixel having a depth value indicating distance from the view in a position of the pixel having a depth value indicating proximity to the view on the reference depth map for each set of pixels of the reference depth map adjacent to the occlusion generation pixel border.

The picture encoding method of the present invention may further include: an object region determination step of determining an object region on the virtual depth map for a region shielding the occlusion region on the reference depth map; and an object region extension step of extending a pixel in a direction of the occlusion region in the object region, wherein the occlusion region depth generation step includes generating the depth value of the occlusion region by smoothly interpolating the depth value between a pixel generated through the extension and a pixel adjacent to the occlusion region and present in an opposite direction from the object region.

In the picture encoding method of the present invention, the depth map conversion step may include obtaining a corresponding pixel on the virtual depth map for each reference pixel of the reference depth map and performing conversion to a virtual depth map by assigning a depth indicating the same three-dimensional position as the depth for the reference pixel to the corresponding pixel.

Further, the present invention is a picture decoding method for performing decoding a decoding target picture of a multiview picture while predicting a picture between views using a decoded reference picture and a reference depth map that is a depth map of an object in the reference picture, the method comprising: a depth map conversion step of converting the reference depth map into a virtual depth map that is a depth map of the object in the decoding target picture; an occlusion region depth generation step of generating a depth value of an occlusion region in which there is no depth value assigned in the reference depth map generated by an anteroposterior relationship of the object by assigning a depth value of which a correspondence relationship with a region on the same object as the object shielded in the reference picture is obtained to the occlusion region; and an inter-view picture prediction step of performing picture prediction between the views by generating a disparity-compensated picture for the decoding target picture from the virtual depth map and the reference picture after the depth value of the occlusion region is generated.

In the picture decoding method of the present invention, the occlusion region depth generation step may include generating the depth value of the occlusion region on an assumption of continuity of an object shielding the occlusion region on the reference depth map.

The picture decoding method of the present invention may further include: an occlusion generation pixel border determination step of determining a pixel border on the reference depth map corresponding to the occlusion region, wherein the occlusion region depth generation step includes generating the depth value of the occlusion region by converting a depth of an assumed object into a depth on the encoding target picture on an assumption that an object continuously exists from the same depth value as a depth value of a pixel having a depth value indicating proximity to the view to the same depth value as a depth value of a pixel having a depth value indicating distance from the view in a position of the pixel having a depth value indicating proximity to the view on the reference depth map for each set of pixels of the reference depth map adjacent to the occlusion generation pixel border.

The picture decoding method of the present invention may further include: an object region determination step of determining an object region on the virtual depth map for a region shielding the occlusion region on the reference depth map; and an object region extension step of extending a pixel in a direction of the occlusion region in the object region, wherein the occlusion region depth generation step includes generating the depth value of the occlusion region by smoothly interpolating the depth value between a pixel generated through the extension and a pixel adjacent to the occlusion region and present in an opposite direction from the object region.

In the picture decoding method of the present invention, the depth map conversion step may include obtaining a corresponding pixel on the virtual depth map for each reference pixel of the reference depth map and performing conversion to a virtual depth map by assigning a depth indicating the same three-dimensional position as the depth for the reference pixel to the corresponding pixel.

The present invention is a picture encoding apparatus for performing encoding a multiview picture which includes pictures for a plurality of views while predicting a picture between the views using an encoded reference picture for a view different from a view of an encoding target picture and a reference depth map that is a depth map of an object in the reference picture, the apparatus including: a depth map conversion unit that converts the reference depth map into a virtual depth map that is a depth map of the object in the encoding target picture; an occlusion region depth generation unit that generates a depth value of an occlusion region in which there is no depth value assigned in the reference depth map generated by an anteroposterior relationship of the object by assigning a depth value of which a correspondence relationship with a region on the same object as the object shielded in the reference picture is obtained to the occlusion region; and an inter-view picture prediction unit that performs picture prediction between the views by generating a disparity-compensated picture for the encoding target picture from the virtual depth map and the reference picture after the depth value of the occlusion region is generated.

In the picture encoding apparatus of the present invention, the occlusion region depth generation unit may generate the depth value of the occlusion region by assuming continuity of the object shielding the occlusion region on the reference depth map.

Further, the present invention is a picture decoding apparatus for performing decoding a decoding target picture of a multiview picture while predicting an picture between views using a decoded reference picture and a reference depth map that is a depth map of an object in the reference picture, the apparatus comprising: a depth map conversion unit that converts the reference depth map into a virtual depth map that is depth map of the object in the decoding target picture; an occlusion region depth generation unit that generates a depth value of an occlusion region in which there is no depth value assigned in the reference depth map generated by an anteroposterior relationship of the object by assigning a depth value of which a correspondence relationship with a region on the same object as the object shielded in the reference picture is obtained to the occlusion region; and an inter-view picture prediction unit that performs picture prediction between views by generating a disparity-compensated picture for the decoding target picture from the virtual depth map and the reference picture after the depth value of the occlusion region is generated.

In the picture decoding apparatus of the present invention, the occlusion region depth generation unit generates the depth value of the occlusion region by assuming continuity of the object shielding the occlusion region on the reference depth map.

The present invention is a picture encoding program that causes a computer to execute the picture encoding method.

The present invention is a picture decoding program to let a computer carry out the picture decoding method.

The present invention is a computer-readable recording medium having the picture encoding program recorded thereon.

The present invention is a computer-readable recording medium having the picture decoding program recorded thereon.

### Advantageous Effects of the Invention

According to the present invention, high encoding efficiency and reduction of a memory capacity and a calculation amount can be realized while suppressing degradation of the quality of the view-synthesized picture when generating the view-synthesized picture of the target frame for the encoding process or decoding process using the depth map for the reference frame is obtained.

### BRIEF DESCRIPTION OF DRAWINGS

FIG. 1 is a block diagram showing a configuration of a picture encoding apparatus in an embodiment of the present invention.

FIG. 2 is a flowchart showing an operation of the picture encoding apparatus shown in FIG. 1.

FIG. 3 is a flowchart showing another example of an operation of encoding an encoding target picture in the picture encoding apparatus shown in FIG. 1.

FIG. 4 is a flowchart showing a processing operation of a process of converting a reference camera depth map operation shown in FIGS. 2 and 3.

FIG. 5 is a flowchart showing an operation of generating a virtual depth map from a reference camera depth map in a depth map conversion unit shown in FIG. 1.

FIG. 6 is a block diagram showing a configuration of a picture decoding apparatus in an embodiment of the present invention.

FIG. 7 is a flowchart showing an operation of the picture decoding apparatus shown in FIG. 6.

FIG. 8 is a flowchart showing another example of an operation of decoding a decoding target picture in the picture decoding apparatus shown in FIG. 6.

FIG. 9 is a block diagram showing another example of a configuration of a picture encoding apparatus of an embodiment of the present invention.

FIG. 10 is a block diagram showing another example of a configuration of a picture decoding apparatus of an embodiment of the present invention.

FIG. 11 is an illustrative diagram showing an occlusion region generated in an encoding target frame.

FIG. 12 is an illustrative diagram showing an operation of generating a depth for an occlusion region in an embodiment of the present invention.

FIG. 13 is a cross-sectional diagram showing a conventional process of generating a virtual depth map of an encoding target region including an occlusion region on the assumption of continuity of a background object.

FIG. 14 is a cross-sectional diagram showing another example of a conventional process of generating a virtual depth map of an encoding target region including the occlusion region on the assumption of continuity of a foreground object and a background object.

FIG. 15 is a cross-sectional diagram showing a process of an embodiment of the present invention of generating a virtual depth map of an encoding target region including an occlusion region on the assumption of continuity of a foreground object.

FIG. 16 is a cross-sectional diagram showing a process of another embodiment of the present invention of generating a virtual depth map of an encoding target region including an occlusion region on the assumption of continuity of an object after extending a foreground object.

FIG. 17 is a cross-sectional diagram showing a process of an embodiment of the present invention of generating a disparity-compensated picture of an encoding target region including an occlusion region generated using the virtual depth map shown in FIG. 15.

FIG. 18 is a cross-sectional diagram showing a process of another embodiment of the present invention of generating a disparity-compensated picture of an encoding target region including an occlusion region generated using the virtual depth map shown in FIG. 16.

FIG. 19 is a cross-sectional diagram showing a conventional process of generating a disparity-compensated picture of an encoding target region including an occlusion region generated using the virtual depth map shown in FIG. 13.

FIG. 20 is a cross-sectional diagram showing another example of a conventional process of generating a disparity-compensated picture of an encoding target region including an occlusion region generated using the virtual depth map shown in FIG. 14.

FIG. 21 is a cross-sectional diagram showing disparity generated between cameras (view).

FIG. 22 is a conceptual diagram showing an epipolar geometric constraint.

### EMBODIMENTS FOR CARRYING OUT THE INVENTION

Hereinafter, a picture encoding apparatus and a picture decoding apparatus according to embodiments of the present invention will be described with reference to the drawings. The following description assumes a case in which a multiview picture captured by two cameras including a first camera (referred to as camera A) and a second camera (referred to as camera B) is encoded, and the description will be given on the assumption that a picture from camera B is encoded or decoded using a picture from camera A as a reference picture.

Further, information necessary for obtaining a disparity from depth information is assumed to be separately given. Specifically, the information is an external parameter representing a positional relationship between the camera A and camera B or an internal parameter representing projection information for picture planes by the cameras, but other information in other forms may be given as long as the disparity is obtained from the depth information. Detailed description relating to these camera parameters is described in, for example, a document “Oliver Faugeras, ‘Three-Dimensional Computer Vision,’ MIT Press; BCTC/UFF-006.37 F259 1993, ISBN: 0-262-06158-9.” A description of a parameter indicating a positional relationship of a plurality of cameras or a parameter representing the information on projection to the picture plane by the camera is described in this document.

The following description assumes that information (coordinate values or an index capable of being associated with the coordinate values) capable of specifying a position sandwiched by symbols [ ] is added to a picture, a video frame, or a depth map to represent a picture signal sampled by a pixel of the position or a depth corresponding thereto. In addition, it is assumed that the depth is information having a smaller value when the distance from a camera is larger (the disparity is less). When the relationship between the magnitude of the depth and the distance from the camera is inversely defined, it is necessary to appropriately interpret the description with respect to the magnitude of the value for the depth.

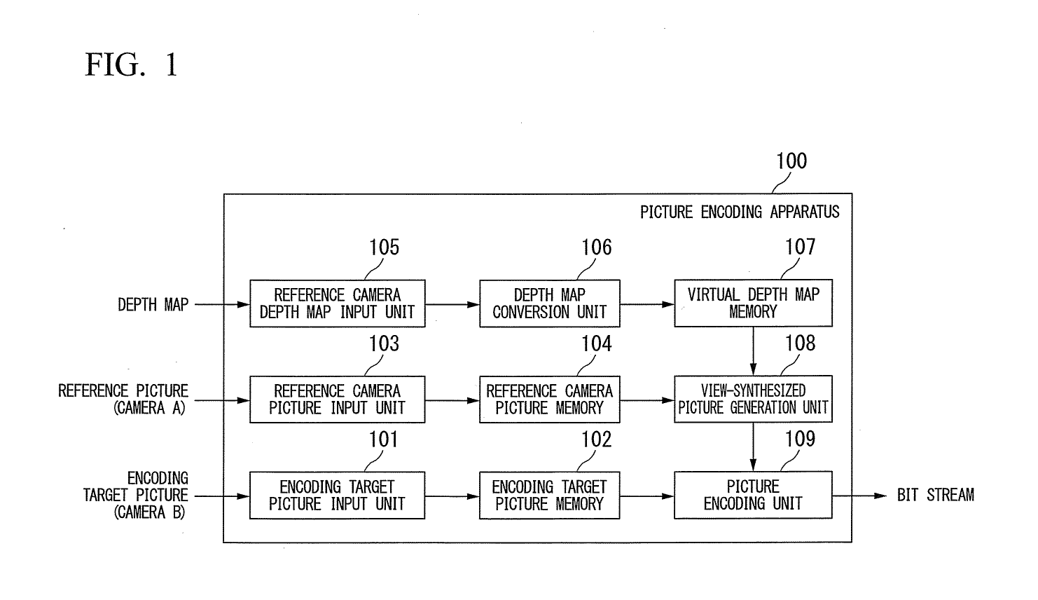

FIG. 1 is a block diagram showing a configuration of a picture encoding apparatus in this embodiment. As shown in FIG. 1, the picture encoding apparatus 100 includes an encoding target picture input unit 101, an encoding target picture memory 102, a reference camera picture input unit 103, a reference camera picture memory 104, a reference camera depth map input unit 105, a depth map conversion unit 106, a virtual depth map memory 107, a view-synthesized picture generation unit 108, and a picture encoding unit 109.

The encoding target picture input unit 101 inputs a picture that is an encoding target. Hereinafter, the picture that is an encoding target is referred to as an encoding target picture. Here, a picture from camera B is input thereto. Further, a camera (here, camera B) capturing the encoding target picture is referred to as an encoding target camera. The encoding target picture memory 102 stores the input encoding target picture. The reference camera picture input unit 103 inputs a picture that is a reference picture when a view-synthesized picture (disparity-compensated picture) is generated. Here, the picture from camera A is input thereto. The reference camera picture memory 104 stores the input reference picture.

The reference camera depth map input unit 105 inputs a depth map for the reference picture.

Hereinafter, the depth map for this reference picture is referred to as a reference camera depth map or a reference depth map. Further, the depth map indicates a three-dimensional position of an object photographed in each pixel of a corresponding picture. When a three-dimensional position is obtained based on the information such as a separately given camera parameter, the information may be any information. For example, a distance from the camera to the object, a coordinate value for an axis that is not parallel to the picture plane, and a disparity amount for a different camera (for example, camera B) can be used. Further, while the depth map is in the form of a picture herein, the depth map may not be in the form of the picture as long as the same information is obtained. Hereinafter, a camera corresponding to the reference camera depth map is referred to as a reference camera.

The depth map conversion unit 106 generates a depth map for the encoding target picture using the reference camera depth map (reference depth map). The depth map generated for the encoding target picture is referred to as a virtual depth map. The virtual depth map memory 107 stores the generated virtual depth map.

The view-synthesized picture generation unit 108 obtains a correspondence relationship between the pixel of the encoding target picture and the pixel of the reference camera picture using the virtual depth map obtained from the virtual depth map memory 107 and generates the view-synthesized picture for the encoding target picture. The picture encoding unit 109 performs predictive encoding on the encoding target picture using the view-synthesized picture and outputs a bit stream that is encoded data.

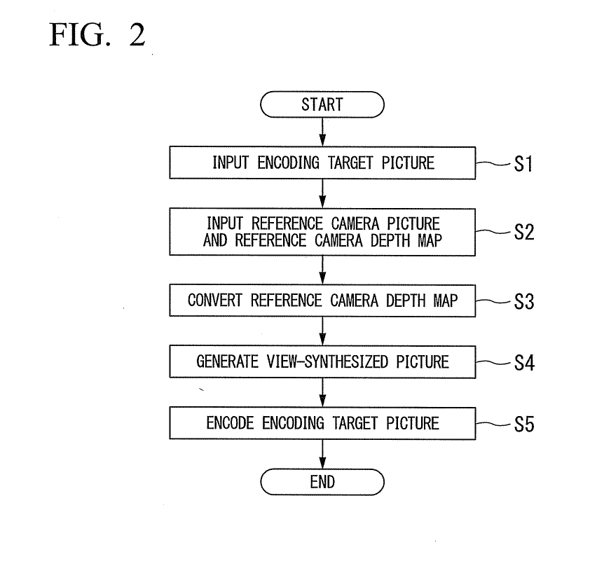

Next, an operation of the picture encoding apparatus 100 shown in FIG. 1 will be described with reference to FIG. 2. FIG. 2 is a flowchart showing an operation of the picture encoding apparatus 100 shown in FIG. 1. First, the encoding target picture input unit 101 inputs the encoding target picture and stores the encoding target picture in the encoding target picture memory 102 (step S1). Then, the reference camera picture input unit 103 inputs the reference camera picture and stores the reference camera picture in the reference camera picture memory 104. In parallel to this, the reference camera depth map input unit 105 inputs the reference camera depth map and outputs the reference camera depth map to the depth map conversion unit 106 (step S2).

Further, the reference camera picture and the reference camera depth map input in step S2 are assumed to be the same as those obtained on the decoding side, such as those obtained by decoding things that have already been encoded. This is because the generation of encoding noise such as drift is suppressed by using exactly the same information as information obtained by a decoding apparatus. However, when generation of such an encoding noise is allowed, things obtained only on the encoding side, including something that has yet to be encoded, may be input. For a reference camera depth map, in addition to a depth map obtained by decoding the depth map that has already been encoded, for example, a depth map estimated by applying stereo matching or the like to the decoded multiview picture with respect to a plurality of cameras or a depth map estimated using the decoded disparity vector, motion vector or the like can be used as a depth map by which the same thing is obtained on the decoding side.

Then, the depth map conversion unit 106 generates a virtual depth map from the reference camera depth map and stores the virtual depth map in the virtual depth map memory 107 (step S3). Details of a process herein will be described below.

Then, the view-synthesized picture generation unit 108 generates a view-synthesized picture for the encoding target picture using the reference camera picture stored in the reference camera picture memory 104 and the virtual depth map stored in the virtual depth map memory 107, and outputs the view-synthesized picture to the picture encoding unit 109 (step S4). In the process herein, any method may be used as long as the method is a method of combining the picture of an encoding object camera using the depth map for the encoding target picture and a picture captured by a camera different from the encoding target camera.

For example, first, one pixel of the encoding target picture is selected, and a corresponding point on the reference camera picture is obtained using the depth value of the corresponding pixel on the virtual depth map. Then, a pixel value of the corresponding point is obtained. Also, the obtained pixel value is assigned as a pixel value of the view-synthesized picture in the same position as the position of the selected pixel of the encoding target picture. The view-synthesized picture for one frame is obtained by performing this process on all the pixels of the encoding target picture. Further, when the corresponding point on the reference camera picture is out of the frame, there may be no pixel value, a predetermined pixel value may be assigned, or a pixel value of a pixel in a closest frame or a pixel value of the pixel in the closest frame in an epipolar straight line shape may be assigned. However, it is necessary to use the same determination method as that on the decoding side. Further, a filter such as a low pass filter may be applied after the view-synthesized picture for one frame is obtained.

Then, after the view-synthesized picture is obtained, the picture encoding unit 109 predictively encodes the encoding target picture using the view-synthesized picture as a predictive picture and outputs the resultant picture (step S5). A bit stream obtained as a result of encoding becomes an output of the picture encoding apparatus 100. Further, any method may be used for encoding as long as correct decoding can be performed on the decoding side.

In general moving picture encoding or general picture encoding, such as MPEG-2, H.264 or PEG a picture is divided into blocks having a predetermined size, a differential signal between the encoding target picture and the predictive picture is generated for each block, frequency conversion such as a DCT (discrete cosine transform) is performed on a differential picture, and encoding is performed by sequentially applying quantization, binarization, and entropy encoding processes to the resultant value.

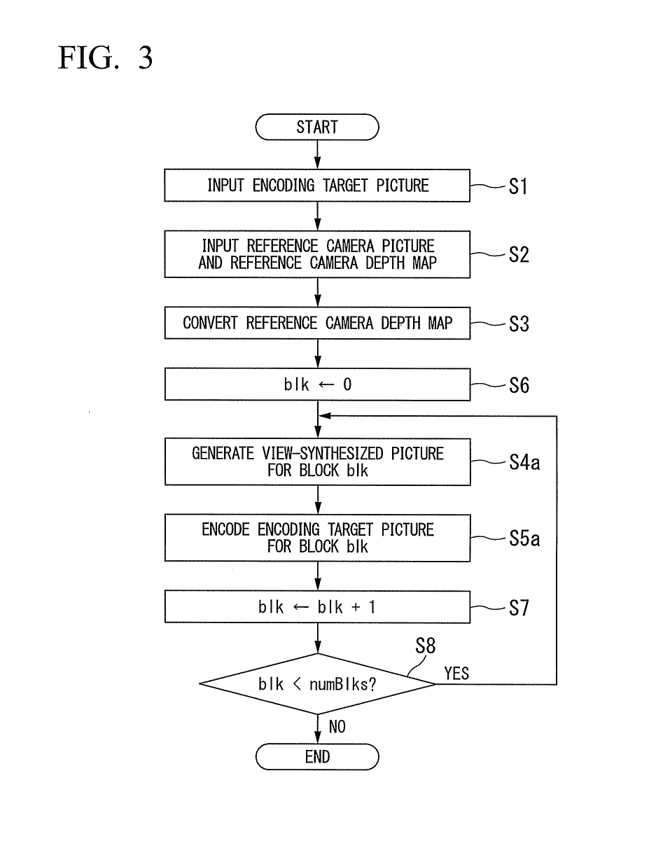

Further, when a predictive encoding process is performed on each block, the process (step S4) of generating the view-synthesized picture and the process (step S5) of encoding the encoding target picture may be alternately repeated for each block to encode the encoding target picture. A processing operation in this case will be described with reference to FIG. 3. FIG. 3 is a flowchart showing an operation of encoding the encoding target picture by alternately repeating the process of generating the view-synthesized picture and the process of encoding the encoding target picture for each block. In FIG. 3, the same parts as those in the processing operation shown in FIG. 2 are denoted with the same signs and a description thereof will be simply given. In the processing operation shown in FIG. 3, an index of a block that is a unit of the predictive encoding process is indicated by blk and the number of blocks in the encoding target picture is indicated by numBlks.

First, the encoding target picture input unit 101 inputs an encoding target picture and stores the encoding target picture in the encoding target picture memory 102 (step S1). Then, the reference camera picture input unit 103 inputs a reference camera picture and stores the reference camera picture in the reference camera picture memory 104. In parallel to this, the reference camera depth map input unit 105 inputs a reference camera depth map and outputs the reference camera depth map to the depth map conversion unit 106 (step S2).

Then, the depth map conversion unit 106 generates a virtual depth map based on the reference camera depth map output from the reference camera depth map input unit 105, and stores the virtual depth map in the virtual depth map memory 107 (step S3). Also, the view-synthesized picture generation unit 108 applies 0 to a variable blk (step S6).

Then, the view-synthesized picture generation unit 108 generates a view-synthesized picture for the block blk from the reference camera picture stored in the reference camera picture memory 104 and the virtual depth map stored in the virtual depth map memory 107 and outputs the view-synthesized picture to the picture encoding unit 109 (step S4a). Subsequently, after the view-synthesized picture is obtained, the picture encoding unit 109 predictively encodes the encoding target picture for the block blk using the view-synthesized picture as a predictive picture and outputs the resultant picture (step S5a). Also, the view-synthesized picture generation unit 108 increments the variable blk (blk←blk+1; step S7), and determines whether blk<numBlks is satisfied (step S8). If it is determined that blk<numBlks is satisfied, the process returns to step S4a to repeat the process, and ends the process at a time point at which blk=numBlks is satisfied.

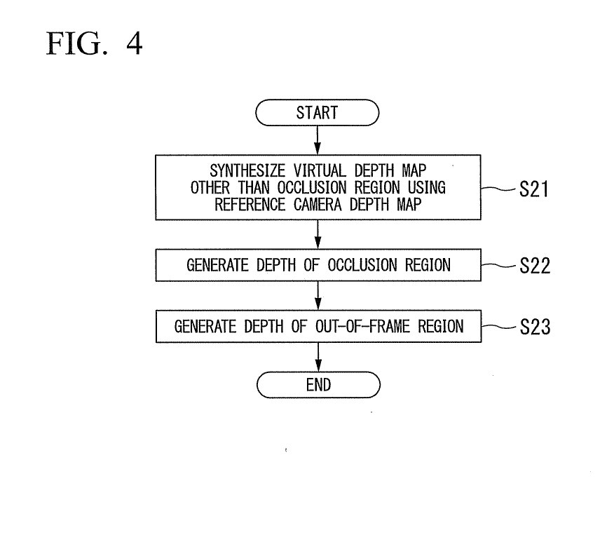

Next, a processing operation of the depth map conversion unit 106 shown in FIG. 1 will be described with reference to FIG. 4.

FIG. 4 is a flowchart showing a processing operation of a conversion process of the reference camera depth map (step S3) shown in FIGS. 2 and 3. In this process, the virtual depth map is generated from the reference camera depth map in three steps. In each step, a depth value is generated for different regions of the virtual depth map.

First, the depth map conversion unit 106 generates a virtual depth map for a region photographed in both of the encoding target picture and the reference camera depth map (step S21). Since this region is depth information included in the reference camera depth map and is information that will also be in the virtual depth map, a virtual depth map is obtained by converting the reference camera depth map. Any process may be used. For example, the method described in Non-Patent Document 3 may be used.

In another method, since the three-dimensional position of each pixel is obtained from the reference camera depth map, a virtual depth map for the region can be generated by restoring a three-dimensional model of the object space and obtaining a depth when the restored model is observed from the encoding target camera. In still another method, the virtual depth map can be generated by obtaining a corresponding point on the virtual depth map using the depth value of the pixel for each pixel of the reference camera depth map and assigning the converted depth value to the corresponding point. Here, the converted depth value is a depth value for the virtual depth map converted from the depth value for the reference camera depth map. When a common coordinate system between the reference camera depth map and the virtual depth map is used as a coordinate system representing the depth value, the depth value of the reference camera depth map is used without conversion.

Further, since the corresponding point is not necessarily obtained as an integer pixel position of the virtual depth map, it is necessary to perform interpolation and generate a depth value for each pixel of the virtual depth map by assuming the continuity on the virtual depth map with an adjacent pixel on the reference camera depth map. However, with respect to the adjacent pixel on the reference camera depth map, the continuity is assumed only when a change in depth value is in a predetermined range. This is because a different object is considered to be photographed in a pixel having a greatly different depth value, and continuity of the object in the real space cannot be assumed. Further, one or a plurality of integer pixel positions may be obtained from the obtained corresponding point and the converted depth value may be assigned to this pixel. In this case, it is not necessary to interpolate the depth value and it is possible to reduce a calculation amount.

Further, since a region of part of the reference camera picture is shielded by another region of the reference camera picture according to an anteroposterior relationship of the object and there is a region that is not photographed in the encoding target picture, it is necessary to assign a depth value to the corresponding point while considering the anteroposterior relationship when this method is used.

However, when the optical axes of the encoding target camera and the reference camera are on the same plane, the virtual depth map can be generated by determining an order in which the pixel of the reference camera depth map is processed according to the positional relationship between the encoding object camera and the reference camera, performing the process in the obtained order, and always performing an overwriting process on the obtained corresponding point without consideration of the anteroposterior relationship. Specifically, when the encoding target camera is present to the right relative to the reference camera, the process is performed in an order in which the pixels of the reference camera depth map are scanned from the left to the right in each row, and when the encoding target camera is present to the left relative to the reference camera, the process is performed in an order in which the pixels of the reference camera depth map are scanned from the right to the left in each row. Accordingly, it is not necessary to consider the anteroposterior relationship. Further, it is possible to reduce a calculation amount since it is not necessary to consider the anteroposterior relationship.

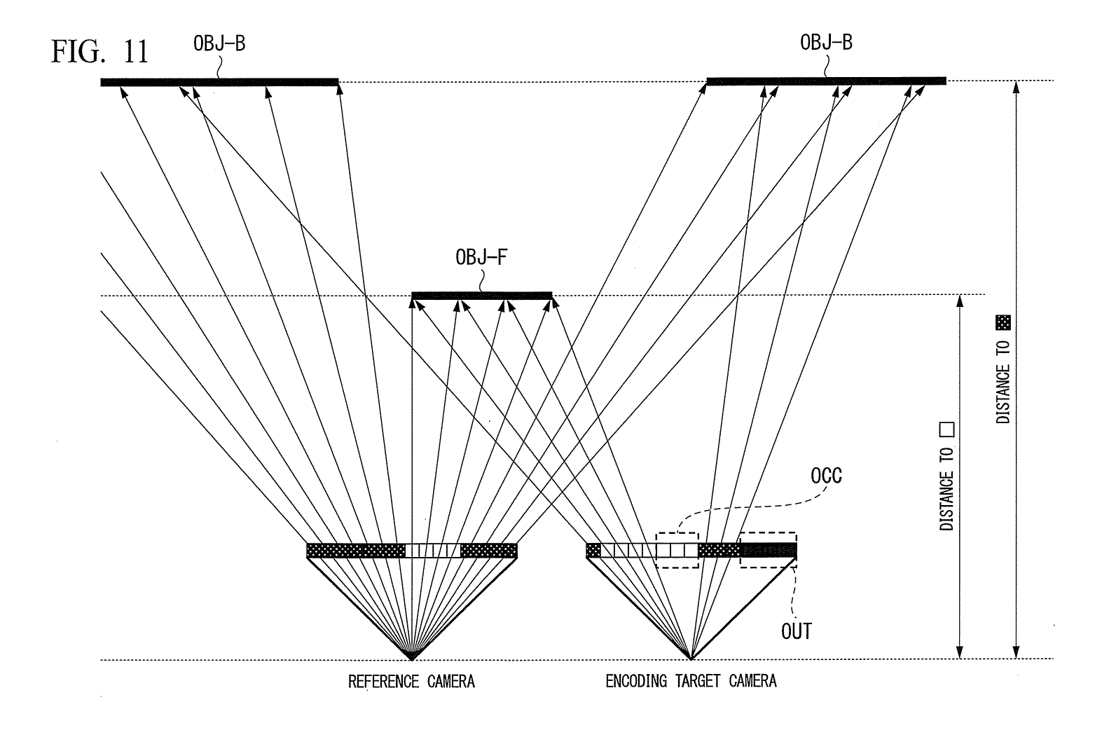

A region of the virtual depth map in which the depth value is not obtained at a time point at which step S21 ends is a region that is not photographed in the reference camera depth map. FIG. 11 is an illustrative diagram showing a situation in which the occlusion region OCC is generated. There are two types of regions, including a region (occlusion region OCC) that is not photographed due to the anteroposterior relationship of the object and a region (out-of-frame region OUT) that is not photographed because it is out of the frame of the reference camera depth map, as shown in FIG. 11. Therefore, the depth map conversion unit 106 generates a depth for the occlusion region OCC (step S22).

A first method of generating a depth for the occlusion region OCC is a method of assigning the same depth value as that of the foreground object OBJ-F around the occlusion region OCC. A depth value assigned to each pixel included in the occlusion region OCC may be obtained or one depth value for a plurality of pixels, including each line included in the occlusion region OCC or the entire occlusion region OCC, may be obtained. Further, when the depth value is obtained for each line of the occlusion region OCC, the depth value may be obtained for each line of pixels of which epipolar straight lines match.

In a specific process, one or more pixels on the virtual depth map in which there is a foreground object OBJ-F shielding a group of pixels of the occlusion region OCC on the reference camera depth map are determined for each set of pixels to which the same depth value is assigned. Then, a depth value to be assigned is determined from the depth value of the determined pixel of the foreground object OBJ-F. When a plurality of pixels are obtained, one depth value is determined based on any one of an average value, an intermediate value, a maximum value, and a most frequent value of the depth values for these pixels. Finally, the determined depth value is assigned to all pixels included in the set of pixels to which the same depth is assigned.

Further, when a pixel in which there is the foreground object OBJ-F is determined for each set of pixels to which the same depth is assigned, a process necessary for determination of a pixel in which there is the foreground object OBJ-F may be reduced by determining a direction on the virtual depth map in which there is an object shielding the occlusion region OCC on the reference camera depth map from the positional relationship between the encoding object camera and the reference camera and performing search only in that direction.

Further, when one depth value is assigned to each line, the depth value may be modified to be smoothly changed so that the depth value is the same in a plurality of lines in the occlusion region OCC far from the foreground object OBJ-F. In this case, the depth value is assumed to be changed to monotonically increase or decrease from a pixel close to the foreground object OBJ-F to a pixel far from the foreground object OBJ-F.

A second method of generating the depth for the occlusion region OCC is a method of assigning a depth value at which a correspondence relationship is obtained, to a pixel on the reference depth map for the background object OBJ-B around the occlusion region OCC. In a specific process, first, one or more pixels for the background object OBJ-B around the occlusion region OCC are selected and determined as a background object depth value for the occlusion region OCC. When a plurality of pixels are selected, one background object depth value is determined based on any one of an average value, an intermediate value, a minimum value, and a most frequent value of the depth values for these pixels.

If the background object depth value is obtained, a minimum depth value is obtained among depth values greater than the background object depth value and having a correspondence relationship with a region corresponding to the background object OBJ-B on the reference camera depth map for each pixel of the occlusion region OCC, and is assigned as a depth value of the virtual depth map.

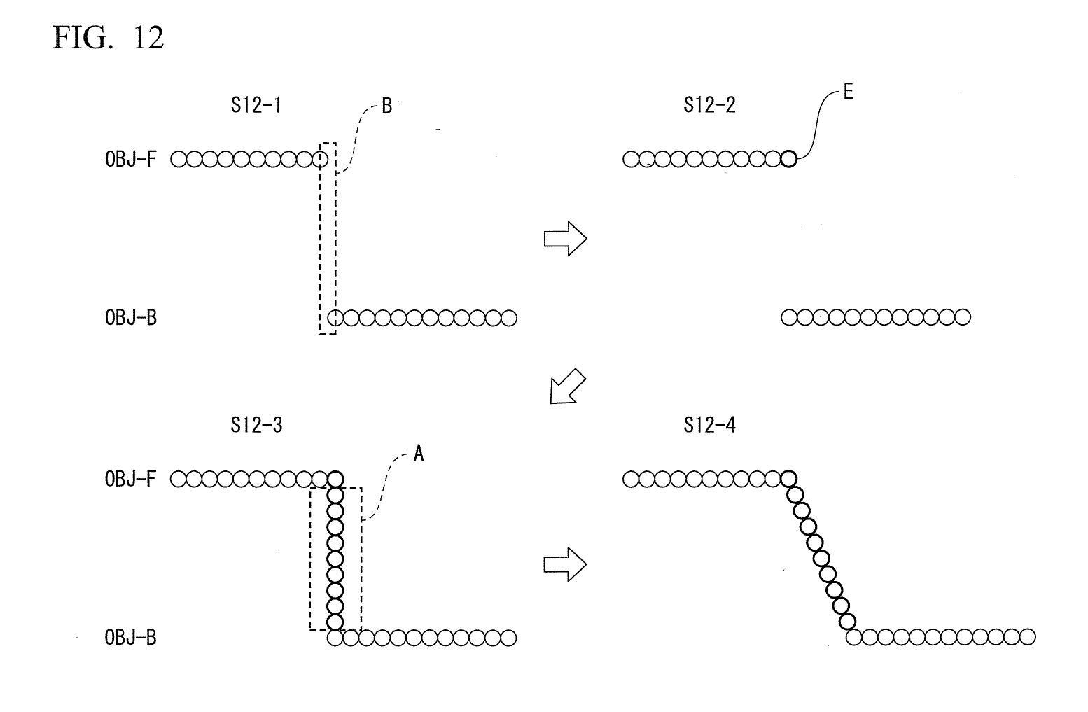

Here, another realization method for the second method of generating the depth for the occlusion region OCC will be described with reference to FIG. 12. FIG. 12 is an illustrative diagram showing an operation of generating the depth for the occlusion region OCC.

First, a border between a pixel for the foreground object OBJ-F on the reference camera depth map and a pixel for the background object OBJ-B, which is a border B in which the occlusion region OCC is generated in the virtual depth map, is obtained (S12-1). Then, the pixel of the foreground object OBJ-F adjacent to the obtained border extends by one pixel E in a direction of the adjacent background object OBJ-B (S12-2). In this case, the pixel obtained through the extension has two depth values including a depth value for the pixel of the original background object OBJ-B and a depth value for the pixel of the adjacent foreground object OBJ-F.

Then, the foreground object OBJ-F and the background object OBJ-B are assumed (A) to be continuous in the pixel E (S12-3) and a virtual depth map is generated (S12-4). That is, a depth value for the pixel of the occlusion region OCC is determined by assuming that an object continuously exists and converting a depth of the assumed object into a depth on the encoding target picture from the same depth value as that of a pixel having a depth value indicating proximity to the reference camera to the same depth value as that of a pixel having a depth value indicating distance from the reference camera in a position of the pixel E on the reference camera depth map.

Here, the last process corresponds to obtaining a plurality of corresponding points on the virtual depth map for the pixel obtained through the extension while changing the depth value. Further, a depth value for the pixel of the occlusion region OCC may be obtained by obtaining a corresponding point obtained using the depth value for the pixel of the original background object OBJ-B and a corresponding point obtained using the depth value for the pixel of the adjacent foreground object OBJ-F with respect to the pixel obtained through the extension and performing linear interpolation between the corresponding points.

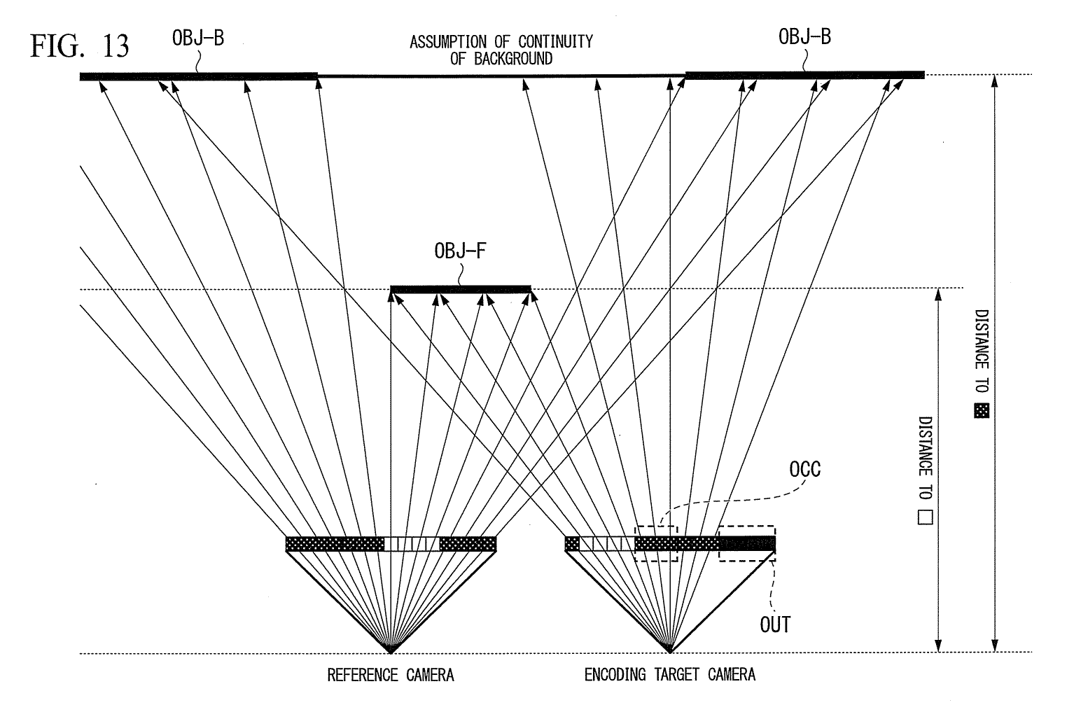

Generally, in the assignment of the depth value to the occlusion region OCC, the occlusion region OCC is a region shielded by the foreground object OBJ-F. Accordingly, in consideration of a structure in such a real space, a depth value for the neighboring background object OBJ-B is assigned on the assumption of continuity of the background object OBJ-B, as shown in FIG. 13.

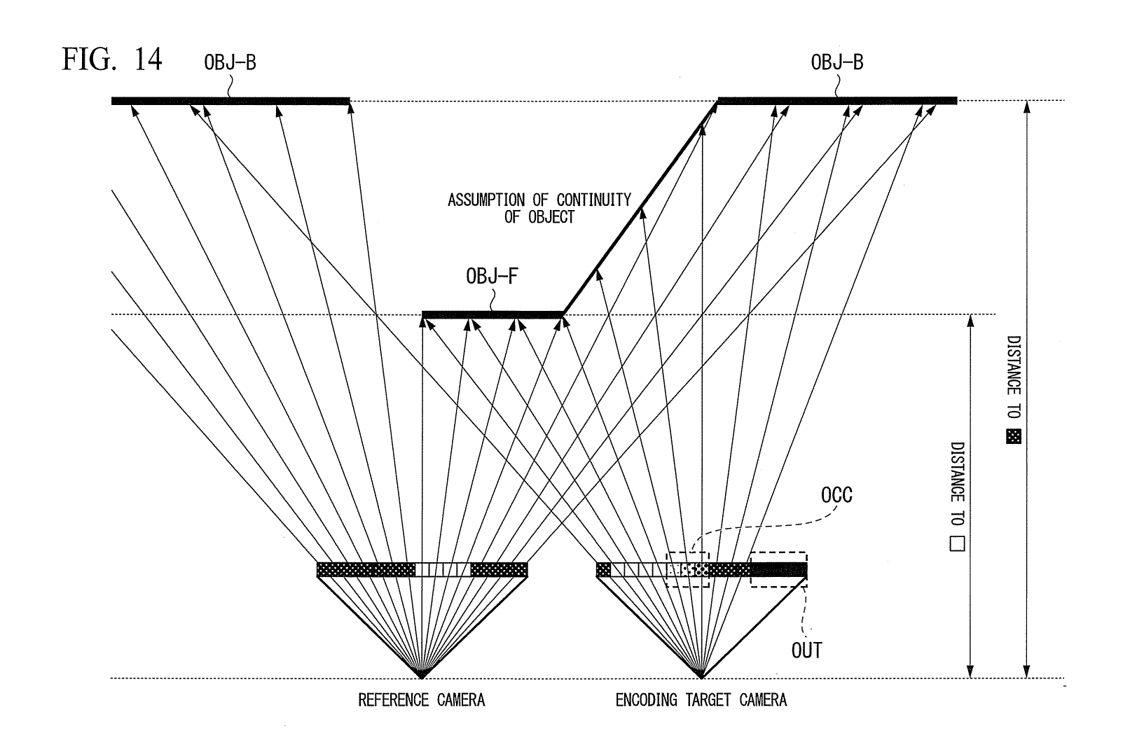

FIG. 13 is an illustrative diagram showing an operation of assigning a depth value for the background object OBJ-B around the occlusion region OCC on assumption of continuity of the background object OBJ-B. Further, a depth value obtained by performing interpolation between the foreground object OBJ-F and the background object OBJ-B of the peripheral region in consideration of the continuity of the object in the reference camera, as shown in FIG. 14, may be assigned.

FIG. 14 is an illustrative diagram showing an operation of assigning a depth value obtained by performing interpolation between the foreground object OBJ-F and the background object OBJ-B in a peripheral region.

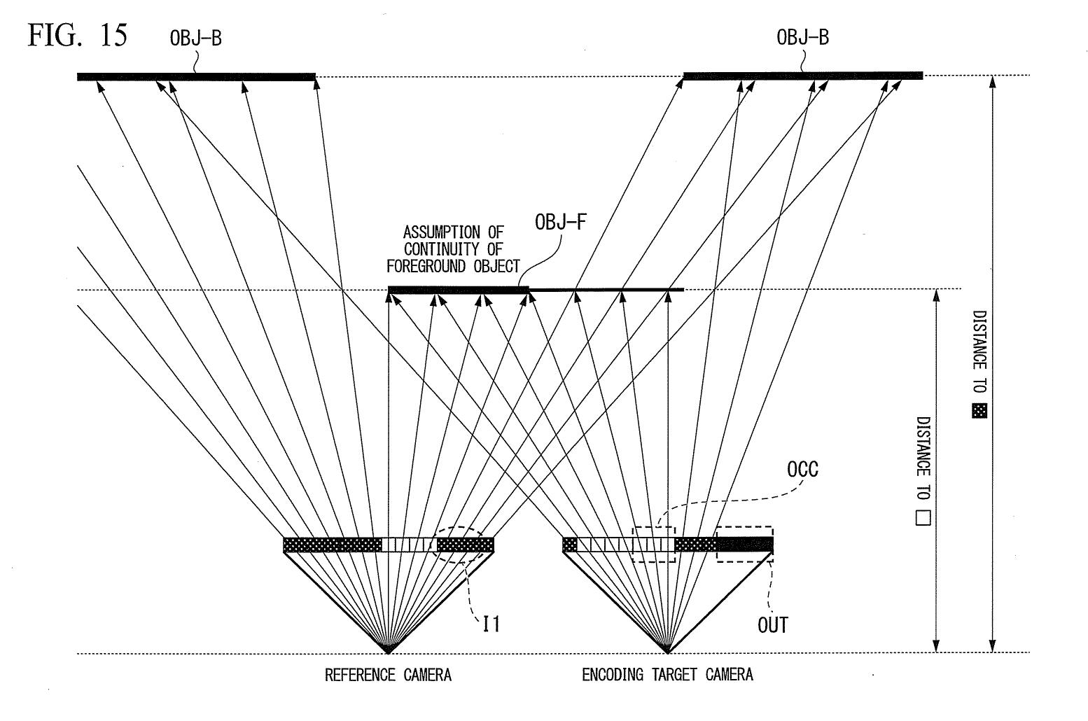

However, the first method of generating the depth for the occlusion region OCC described above is a process in which the structure in a real space is neglected and the continuity of the foreground object OBJ-F is assumed, as shown in FIG. 15. FIG. 15 is an illustrative diagram showing a processing operation in which the continuity of the foreground object OBJ-F is assumed.

In FIG. 15, the virtual depth map of the encoding target frame is generated by giving a depth value of the foreground object OBJ-F to the occlusion region OCC as a depth value.

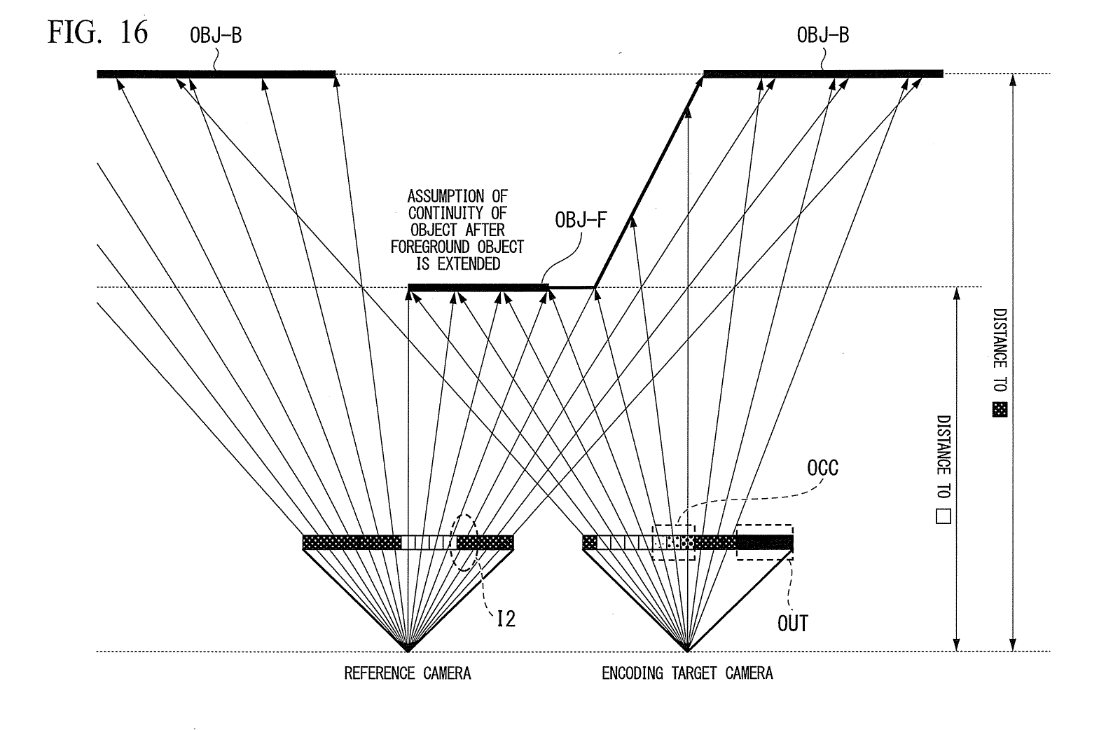

Further, the second method is a process of changing a shape of the object, as shown in FIG. 16. FIG. 16 is an illustrative diagram showing a processing operation of changing a shape of the object.

In FIG. 16, the virtual depth map of the encoding target frame is generated by giving a depth value of an object of which the continuity as shown in S12-4 is assumed to the occlusion region OCC after the foreground object OBJ-F is extended as the depth value as shown in S12-2 of FIG. 12. That is, a depth value continuously changing in a right direction of FIG. 16 from a depth value indicating proximity to the view to a depth value indicating distance from the view is given as the depth value to the occlusion region OCC of FIG. 16.

In these assumptions, there is a contradiction to the reference camera depth map given to the reference camera. In practice, when such assumptions are made, it can be confirmed that contradictions I1 and I2 of the depth value occur in pixels surrounded by ellipses indicated by dotted lines in FIGS. 15 and 16. In the case of FIG. 15, in the reference camera depth map, the depth value of the foreground object OBJ-F is in the assumed object space in a position in which the depth value of the background object OBJ-B should be. In the case of FIG. 16, in the reference camera depth map, a depth value of the object connecting the foreground object OBJ-F and the background object OBJ-B is in the assumed object space in a position in which the depth value of the background object OBJ-B should be.

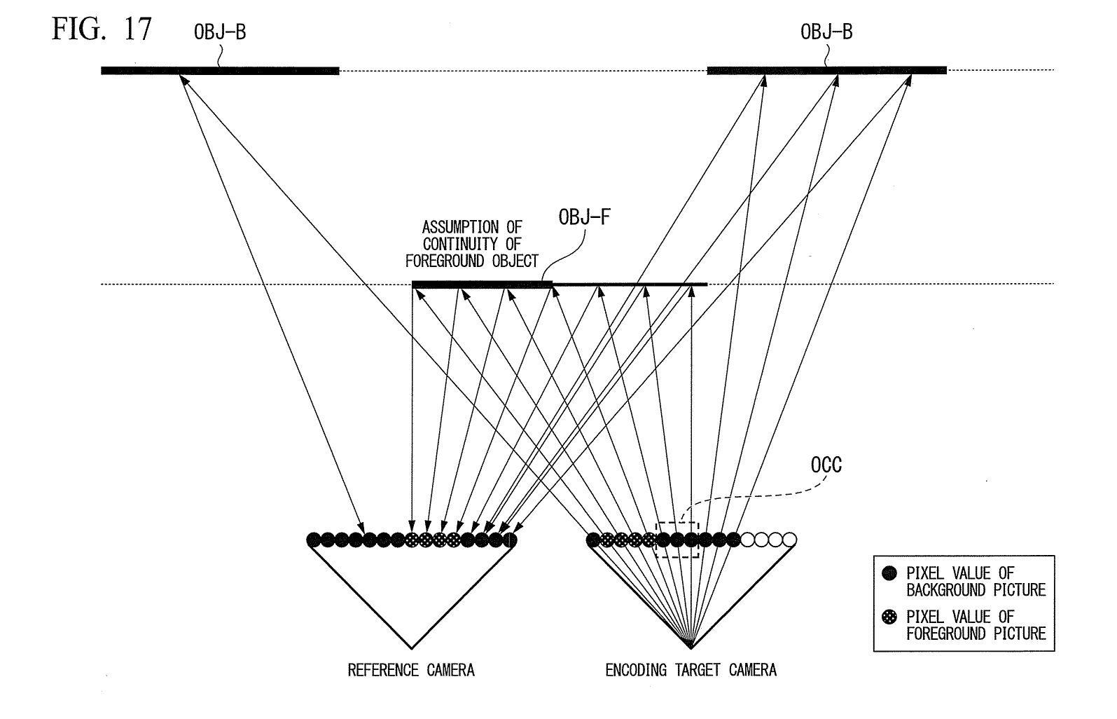

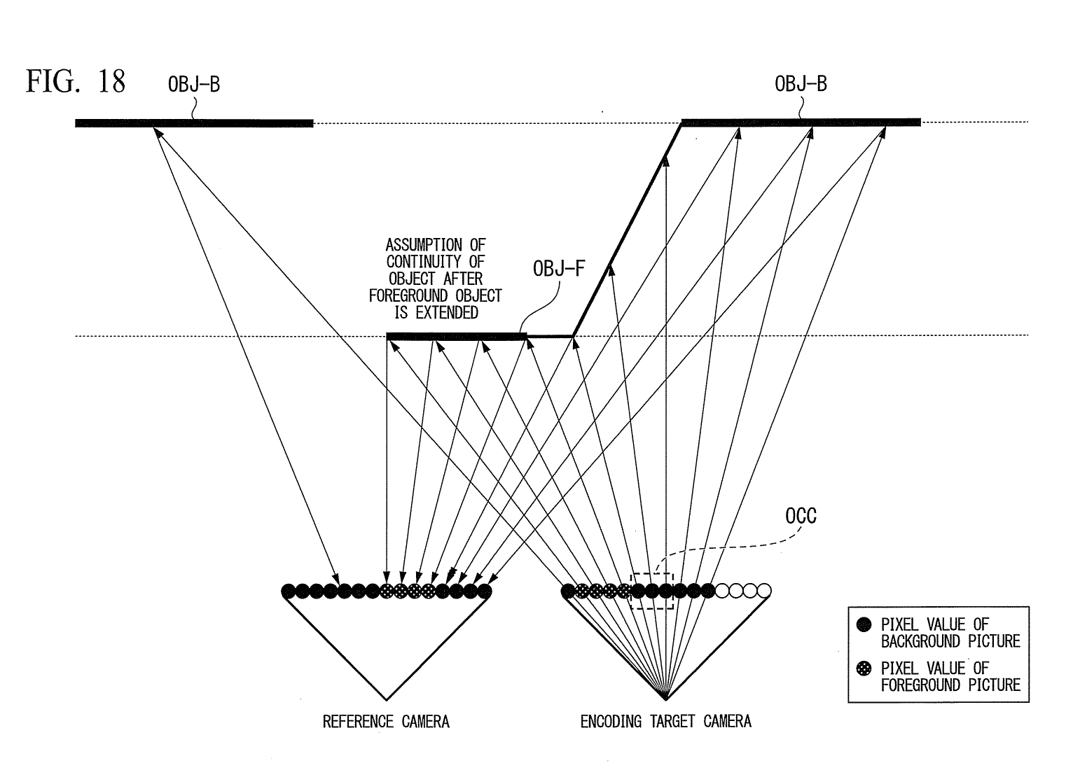

Therefore, in this method, a depth value cannot be generated without contradiction to the occlusion region OCC on the reference camera depth map. However, when a corresponding point is obtained for each pixel of the encoding target picture using the virtual depth map shown in FIGS. 15 and 16 generated in this way so that the view-synthesized picture is synthesized, the pixel value of the background object OBJ-B is assigned to the pixel of the occlusion region OCC, as shown in FIGS. 17 and 18.

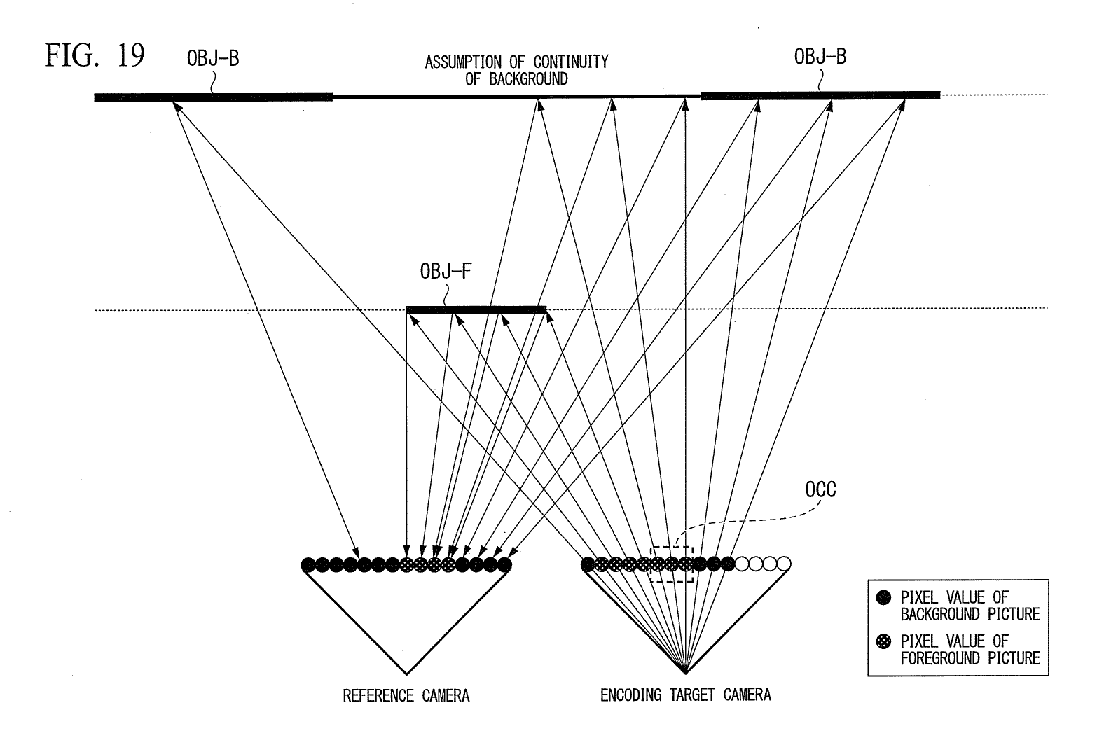

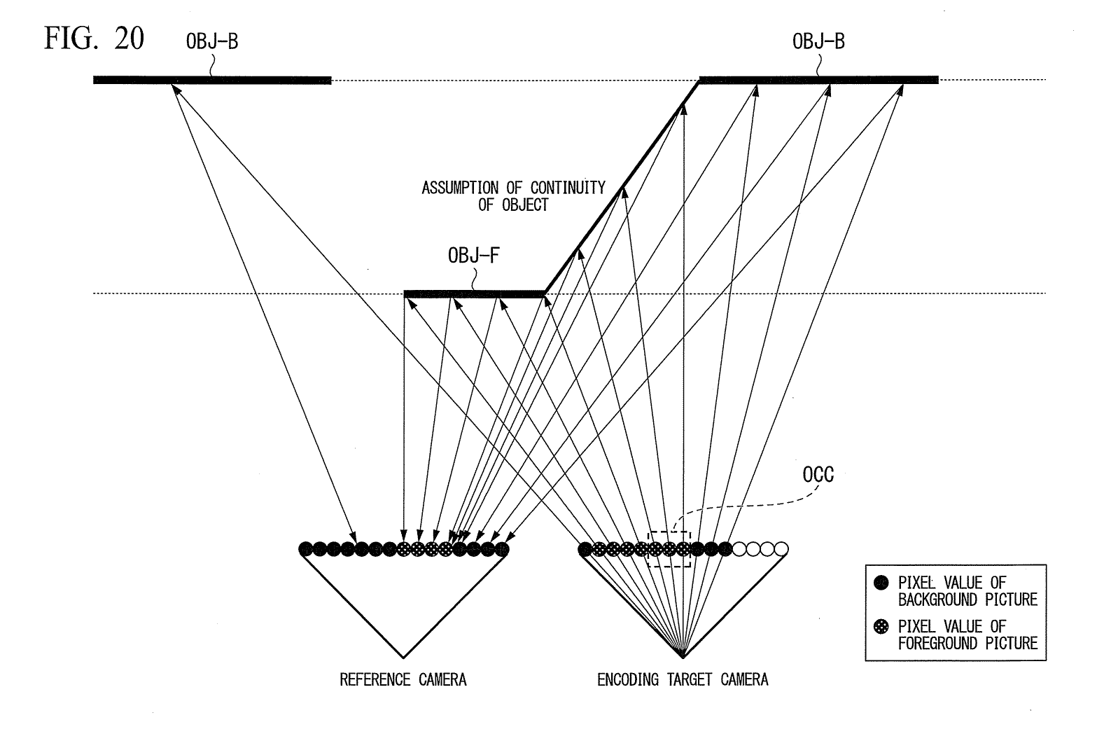

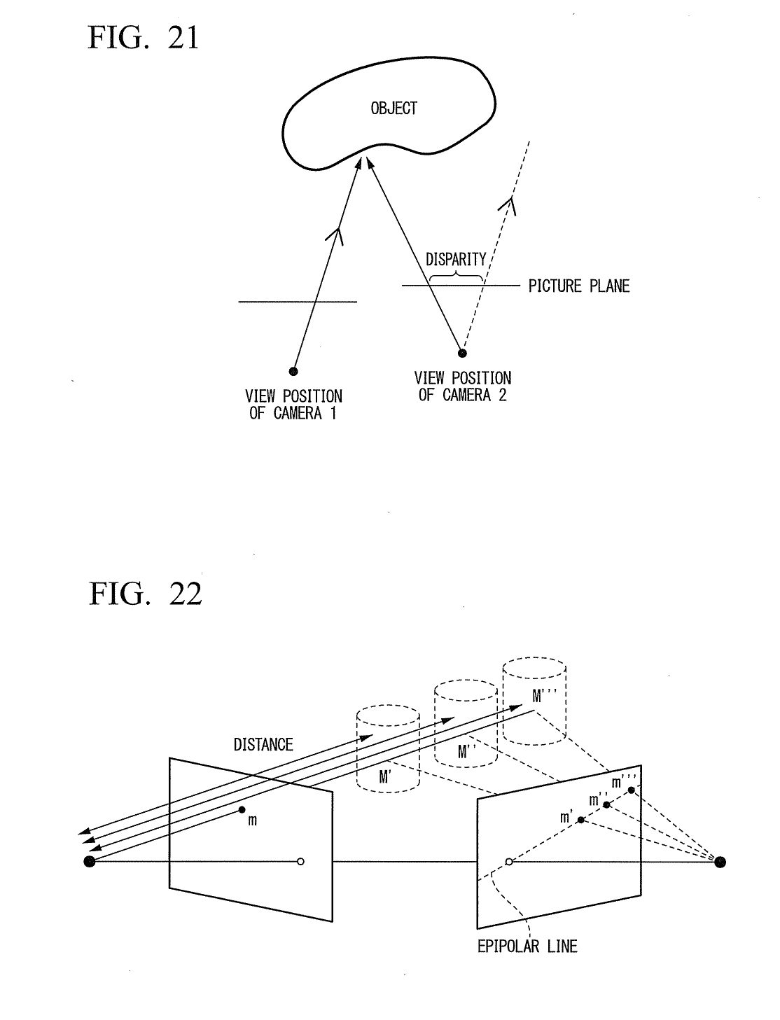

On the other hand, when the virtual depth map in which there is no contradiction is generated in a conventional method, a pixel value of the foreground object OBJ-F is assigned to the pixel of the occlusion region OCC, or a pixel value obtained through interpolation from both the foreground object OBJ-F and the background object OBJ-B is assigned due to correspondence to a middle of the foreground object OBJ-F and the background object OBJ-B, as shown in FIGS. 19 and 20. FIGS. 19 and 20 are illustrative diagrams showing that the pixel value of the foreground object OBJ-F or the interpolated pixel value is assigned. Since the occlusion region OCC is a region shielded by the foreground object OBJ-F, the background object OBJ-B is assumed to exist, and thus a high-quality view-synthesized picture can be generated in the above-described scheme relative to a conventional scheme.

Further, when the view-synthesized picture is generated using the virtual depth map generated using the conventional scheme, it is possible to prevent a wrong view-synthesized picture from being generated by comparing the depth value of the virtual depth map for the pixel of the encoding target picture with the depth value of the reference camera depth map for the corresponding point on the reference camera picture, determining whether shielding occurs due to the foreground object OBJ-F (whether a difference between these depth values is small), and generating the pixel value from the reference camera picture only when the shielding does not occur (the difference between the depth values is small).

However, in such a method, calculation amount increases because of checking for occurrence of shielding. Further, a view-synthesized picture cannot be generated for a pixel in which shielding occurs or it is necessary to generate a view-synthesized picture with an additional calculation amount caused by a scheme such as picture restoration (inpainting). Therefore, a high-quality view-synthesized picture can be generated with a small calculation amount by generating the virtual depth map using the above-described scheme.

Referring back to FIG. 4, if generation of the depth for the occlusion region OCC ends, the depth map conversion unit 106 generates a depth for an out-of-frame region OUT (step S23). Further, one depth value may be assigned to a consecutive out-of-frame region OUT or one depth value may be assigned to each line. Specifically, there is a method of assigning a minimum value of the depth value of the pixel adjacent to the out-of-frame region OUT for which the depth value is determined or an arbitrary depth value smaller than the minimum value.

Further, when the view-synthesized picture is not generated for the out-of-frame region OUT, the depth may not be generated for the out-of-frame region OUT. However, in this case, it is necessary to use a method of generating the view-synthesized picture, in which a pixel value is not assigned or a default pixel value is assigned without obtaining the corresponding point for the pixel to which a valid depth value is not given in the step of generating a view-synthesized picture (step S4 or S4a).

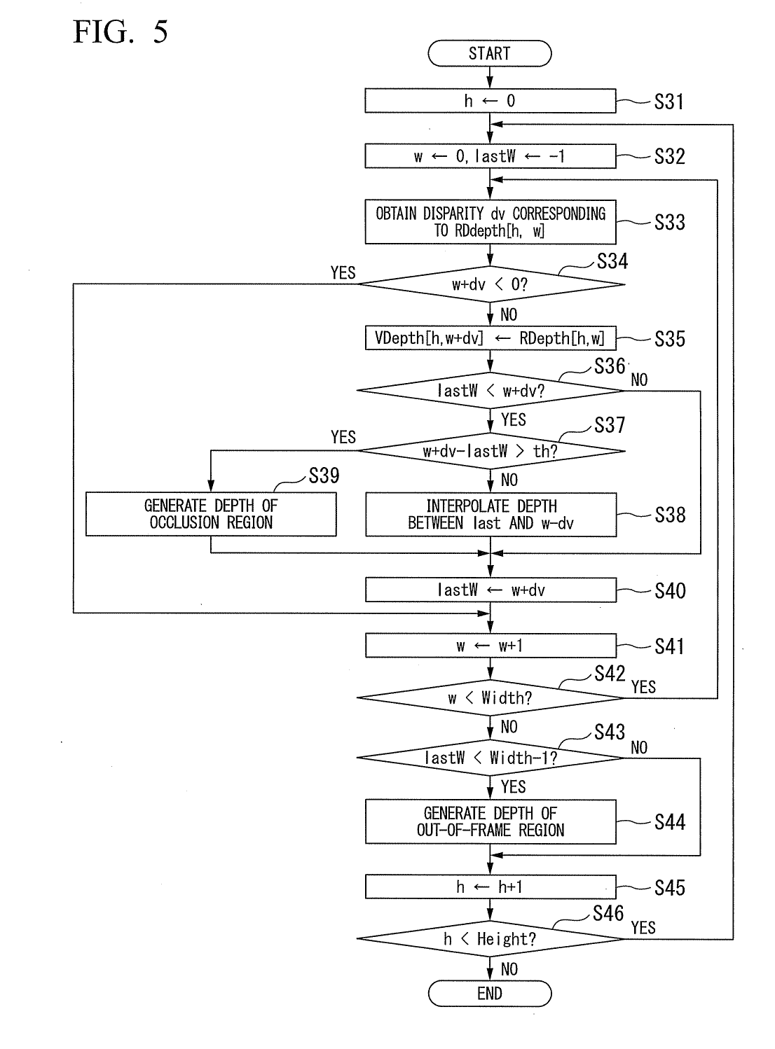

Next, an example of a specific operation of the depth map conversion unit 106 when the camera arrangement is a one-dimensional parallel arrangement will be described with reference to FIG. 5. Further, when the camera arrangement is a one-dimensional parallel arrangement, theoretical projection planes of the cameras are on the same plane, and the optical axes are parallel to each other. Further, here, the cameras are installed adjacent to each other in a horizontal direction, and the reference camera is present on the left side of the encoding target camera. In this case, the epipolar straight line for pixels on the horizontal line on the picture plane is in a horizontal line shape present at the same height. Therefore, the disparity exists only in the horizontal direction. Further, since the projection plane is on the same plane, when the depth is represented as a coordinate value for the coordinate axis in an optical axis direction, a definition axis of the depth matches between the cameras.

FIG. 5 is a flowchart showing an operation in which the depth map conversion unit 106 generates a virtual depth map from the reference camera depth map. In FIG. 5, the reference camera depth map is indicated by RDepth, and the virtual depth map is indicated by VDepth. Since a camera arrangement is a one-dimensional parallel arrangement, the reference camera depth map is converted for each line to generate the virtual depth map. That is, when an index indicating a line of the reference camera depth map is h, and the number of lines of the reference camera depth map is Height, the depth map conversion unit 106 initializes h at 0 (step S31), increments h by 1 (step S45), and repeats subsequent processes (steps S32 to S44) until h reaches Height (step S46).

In the process performed on each line, first, the depth map conversion unit 106 warps the depth of the reference camera depth map (steps S32 to S42). Then, the depth map conversion unit 106 generates a virtual' depth map for one line by generating the depth for the out-of-frame region OUT (steps S43 to S44).

The process of warping the depth of the reference camera depth map is performed on each pixel of the reference camera depth map. That is, when an index indicating a pixel position in a horizontal direction is w and a total number of pixels of one line is Width, the depth map conversion unit 106 initializes w at 0 and a pixel position lastW on the virtual depth map in which a depth of an immediately previous pixel is warped into −1 (step S32), and then repeats the following process (steps S33 to S40) while incrementing w by 1 (step S41) until w reaches Width (step S42).

In the process performed on each pixel of the reference camera depth map, first, the depth map conversion unit 106 obtains a disparity dv for the virtual depth map of a pixel (h, w) from a value of the reference camera depth map (step S33). Here, the process varies according to a definition of the depth.

Further, the disparity dv is assumed to be a vector amount having a direction of the disparity and to indicate that the pixel (h, w) of the reference camera depth map corresponds to a pixel (h, w+dv) on the virtual depth map.

Then, when the disparity dv is obtained, the depth map conversion unit 106 checks if there is the corresponding pixel on the virtual depth map in a frame (step S34). Here, it is checked if w+dv is negative from a restriction due to a positional relationship of the camera. When w+dv is negative, there is no corresponding pixel, and thus the process for the pixel (h, w) ends without warping the depth for the pixel (h, w) of the reference camera depth map.

When w+dv is more than 0, the depth map conversion unit 106 warps a depth for the pixel (h, w) of the reference camera depth map in a corresponding pixel (h, w+dv) of the virtual depth map (step S35). Then, the depth map conversion unit 106 checks a positional relationship between a position in which the depth of an immediately previous pixel is warped and a position in which current warping is performed (step S36). Specifically, a determination is made as to whether an order of right and left on the reference camera depth map of the immediately previous pixel and a current pixel is the same even on the virtual depth map. When the positional relationship is reversed, it is determined that the object close to the camera has been photographed in the currently processed pixel rather than the immediately previously processed pixel, a particular process is not performed, lastW is updated into w+dv (step S40), and the processing for the pixel (h, w) ends.

On the other hand, when the positional relationship is not reversed, the depth map conversion unit 106 generates a depth for the pixel of the virtual depth map between the position lastW in which the depth of the immediately previous pixel is warped and the position w+dv in which current warping is performed. Also, in the process of generating the depth for the pixel of the virtual depth map between the position in which the depth of the immediately previous pixel is warped and the position in which current warping is performed, first, the depth map conversion unit 106 checks if the same object is photographed in the immediately previous pixel and the pixel in which current warping is performed (step S37). The determination may be performed using any method. However, here, a determination on the assumption that a change in the depth for the same object is small from continuity in a real space of the object is made.

Specifically, a determination is made as to whether a difference of disparity obtained from a difference between the position in which the depth of the immediately previous pixel is warped and the position in which the current warping is performed is smaller than a predetermined threshold.

Then, when the difference between the positions is smaller than the threshold, the depth map conversion unit 106 determines that the same object is photographed in the two pixels, and interpolates a depth for the pixel of the virtual depth map between the position lastW in which the depth of the immediately previous pixel is warped and the position w+dv in which current warping is performed on the assumption of the continuity of the object (step S38). Any method may be used for depth interpolation. For example, the depth interpolation may be performed by linearly interpolating the depth of lastW and the depth of w+dv or the depth interpolation may be performed by assigning the same depth as either the depth of lastW or the depth of w+dv.

On the other hand, when the position difference is equal to or more than the threshold, the depth map conversion unit 106 determines that different objects are photographed in the two pixels. Further, it can be determined that the object close to the camera has been photographed in the immediately previously processed pixel rather than the currently processed pixel, based on the positional relationship. That is, there is the occlusion region OCC between the two pixels, and then a depth for this occlusion region OCC is generated (step S39). There are a plurality of methods of generating the depth for the occlusion region OCC, as described above. In the first method described above, when the depth value of the foreground object OBJ-F around the occlusion region OCC is assigned, a depth VDepth[h, lastW] of the immediately previously processed pixel is assigned. On the other hand, in the second method described above, when the foreground object OBJ-F is extended and the depth is assigned continuously with the background, VDepth[h, lastW] is copied to VDepth[h, lastW+1], and a depth for the pixel of the virtual depth between (h, lastW+1) and (h, w+dv) is generated by linearly interpolating the depths of VDepth[h, lastW+1] and VDepth[h, w+dv].

Then, if the generation of the depth for the pixel of the virtual depth map between the position in which the depth of the immediately previous pixel and the position in which current warping is performed ends, the depth map conversion unit 106 updates lastW into w+dv (step S40) and ends the process for the pixel (h, w).

Then, in the process of generating the depth for the out-of-frame region OUT, first, the depth map conversion unit 106 confirms a warping result of the reference camera depth map, and determines whether there is an out-of-frame region OUT (step S43). If there is no out-of-frame region OUT, the process ends without doing anything. On the other hand, when there is the out-of-frame region OUT, the depth map conversion unit 106 generates a depth for the out-of-frame region OUT (step S44). Any method may be used. For example, last warped VDepth[h, lastW] may be assigned to all pixels in the out-of-frame region OUT.

While the processing operation shown in FIG. 5 is a process when the reference camera is installed on the left side of the encoding target camera, an order of pixels to be processed or the condition for determining a pixel position may be reverse when the reference camera and the encoding object camera are placed in reverse order. Specifically, in step S32, w is initialized to Width−1, and lastW is initialized to Width. In step S41, w is decremented by 1, and the above-described process (steps S33 to S40) is repeated until w becomes less than 0 (step S42). Further, the determination condition in step S34 is w+dv≧Width, the determination condition in step S36 is lastW>w+dv, and the determination condition in step S37 is lastW−w−dv>th.

Further, while the processing operation shown in FIG. 5 is a process when the camera arrangement is one-dimensional parallel arrangement, the same processing operation can be applied to a case in which the camera arrangement is one-dimensional convergence due to a definition of the depth. Specifically, the same processing operation can be applied to a case in which a coordinate axis representing the depth is the same in the reference camera depth map and the virtual depth map. Further, when the definition axis of the depth is different, a value of the reference camera depth map is not directly assigned to the virtual depth map, but a three-dimensional position represented by the depth of the reference camera depth map is converted according to the definition axis of the depth, and then assigned to the virtual depth map, and thus the same processing operation can be basically applied.

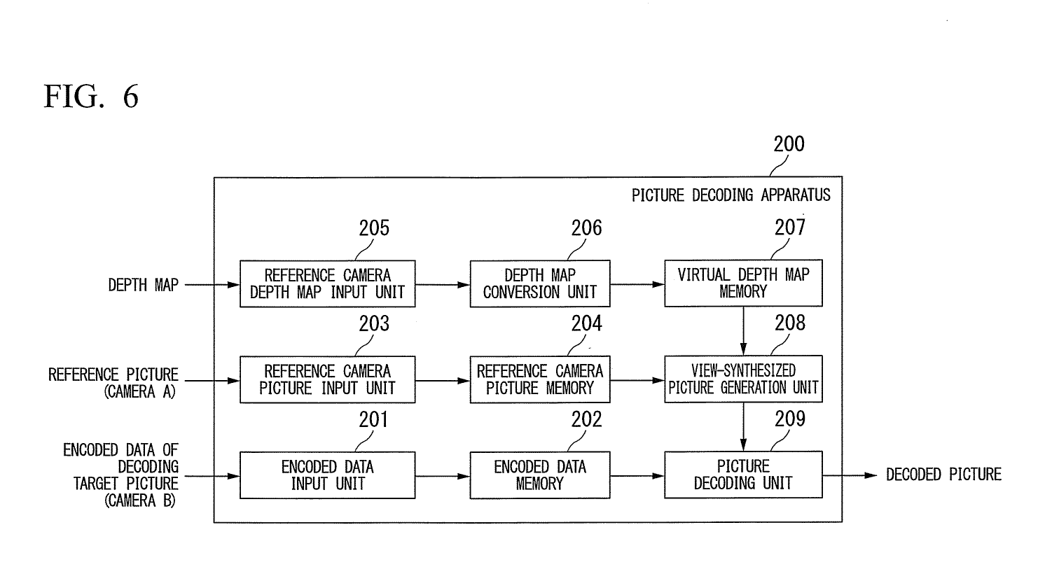

Next, the picture decoding apparatus will be described. FIG. 6 is a block diagram showing a configuration of the picture decoding apparatus in this embodiment. An picture decoding apparatus 200 includes an encoded data input unit 201, an encoded data memory 202, a reference camera picture input unit 203, a reference camera picture memory 204, a reference camera depth map input unit 205, a depth map conversion unit 206, a virtual depth map memory 207, a view-synthesized picture generation unit 208, and an picture decoding unit 209, as shown in FIG. 6.

The encoded data input unit 201 inputs encoded data that is a decoding target picture. Hereinafter, the picture that is the decoding target is referred to as a decoding target picture. Here, this picture indicates the picture from camera B. Further, hereinafter, a camera (here, camera B) capturing the decoding target picture is referred to as a decoding target camera. The encoded data memory 202 stores the encoded data that is the input decoding target picture. The reference camera picture input unit 203 inputs an picture that is a reference picture when a view-synthesized picture (disparity-compensated picture) is generated. Here, the picture from camera A is input. The reference camera picture memory 204 stores the input reference picture.

The reference camera depth map input unit 205 inputs a depth map for the reference picture.

Hereinafter, the depth map for this reference picture is referred to as a reference camera depth map. Further, the depth map indicates a three-dimensional position of an object photographed in each pixel of a corresponding picture. When a three-dimensional position is obtained based on the information such as a separately given camera parameter, the information may be any information. For example, a distance from the camera to the object, a coordinate value for an axis that is not parallel to an picture plane, and a disparity amount for a different camera (for example, camera B) may be used. Further, while the depth map is in the form of an picture herein, the depth map may not be in the form of the picture as long as the same information is obtained. Hereinafter, a camera corresponding to the reference camera depth map is referred to as a reference camera.

The depth map conversion unit 206 generates a depth map for the decoding target picture using the reference camera depth map. Hereinafter, the depth map generated for this decoding target picture is referred to as a virtual depth map. The virtual depth map memory 207 stores the generated virtual depth map. The view-synthesized picture generation unit 208 generates a view-synthesized picture for the decoding target picture using the correspondence relationship between the pixel of the decoding target picture obtained from the virtual depth map and the pixel of the reference camera picture. The picture decoding unit 209 decodes the decoding target picture from the encoded data using the view-synthesized picture and outputs a decoded picture.

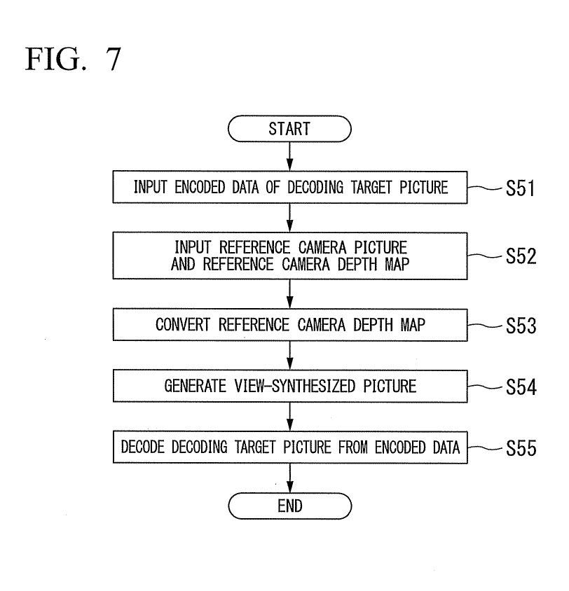

Next, an operation of the picture decoding apparatus 200 shown in FIG. 6 will be described with reference to FIG. 7. FIG. 7 is a flowchart showing an operation of the picture decoding apparatus 200 shown in FIG. 6. First, the encoded data input unit 201 inputs encoded data of a decoding target picture and stores the encoded data in the encoded data memory 202 (step S51). In parallel to this, the reference camera picture input unit 203 inputs a reference picture and stores the reference picture in the reference camera picture memory 204. Further, the reference camera depth map input unit 205 inputs a reference camera depth map and outputs the reference camera depth map to the depth map conversion unit 206 (step S52).

Further, the reference camera picture and the reference camera depth map input in step S52 are the same as those used on the encoding side. This is because generation of encoding noise such as drift is suppressed by using exactly the same information as the information used in the encoding apparatus. However, when generation of such an encoding noise is allowed, different information from that used at the time of encoding may be input. For the reference camera depth map, for example, a depth map estimated by applying stereo matching to the decoded multiview picture with respect to a plurality of cameras, or a depth map estimated using a decoded disparity vector, a motion vector or the like may be used in addition to a separately decoded depth map.

Then, the depth map conversion unit 206 converts the reference camera depth map to generate a virtual depth map and stores the virtual depth map in the virtual depth map memory 207 (step S53). Here, the process is the same as step S3 shown in FIG. 2 except that encoding and the decoding, including the decoding target picture and the encoding target picture, are different.

Then, after the virtual depth map is obtained, the view-synthesized picture generation unit 208 generates the view-synthesized picture for the decoding target picture from the reference camera picture stored in the reference camera picture memory 204 and the virtual depth map stored in the virtual depth map memory 207, and outputs the view-synthesized picture to the picture decoding unit 209 (step S54). Here, the process is the same as step S4 shown in FIG. 2 except that encoding and decoding, including the encoding target picture and the decoding target picture, are different.

Then, after the view-synthesized picture is obtained, the picture decoding unit 209 decodes the decoding target picture from the encoded data while using the view-synthesized picture as a predictive picture, and outputs a decoded picture (step S55). The decoded picture obtained as a result of this decoding becomes the output of the picture decoding apparatus 200. Further, when the encoded data (bit stream) can be correctly decoded, any method may be used for decoding. Generally, a method corresponding to the method used at the time of encoding is used.

When the picture has been encoded using general moving picture encoding or general picture encoding, such as MPEG-2, H.264 or JPEG, decoding is performed by dividing the picture into blocks having a predetermined size, performing, for example, entropy decoding, reverse binarization, and reverse quantization on each block, performing reverse frequency conversion such as an IDCT to obtain a predictive residual signal, and then adding a predictive picture to perform clipping in a pixel value range.

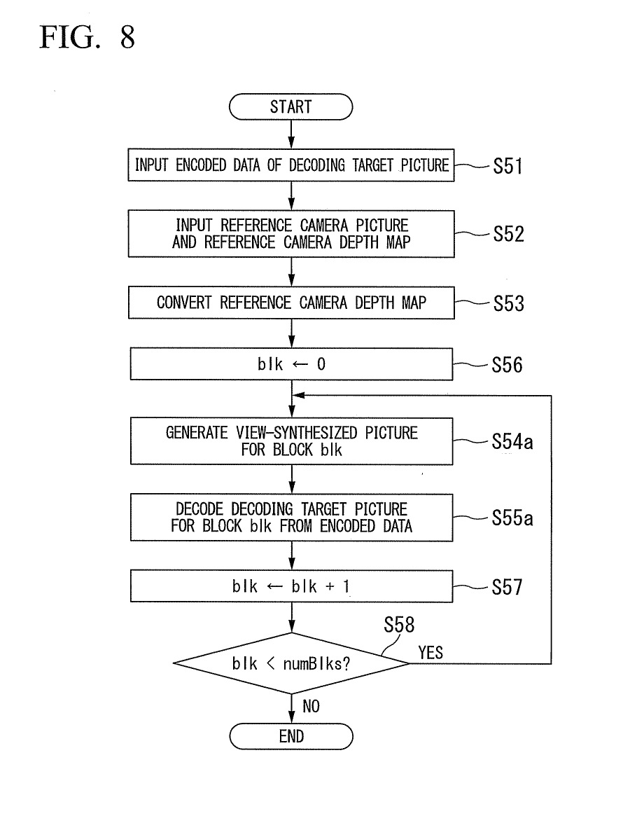

Further, when the decoding process is performed on each block, the decoding target picture may be decoded by alternately repetitively performing the view-synthesized picture generation process and the decoding target picture decoding process on each block. The processing operation in this case will be described with reference to FIG. 8. FIG. 8 is a flowchart showing an operation in which the decoding target picture is decoded by alternately repetitively performing the view-synthesized picture generation process and the decoding target picture decoding process on each block. In FIG. 8, the same parts as those in the processing operation shown in FIG. 7 are denoted with the same signs, and a description thereof will be simply given. In the processing operation shown in FIG. 8, an index of a block that is a unit of the decoding process is indicated by blk, and the number of blocks in the decoding target picture is indicated by numBlks.

First, the encoded data input unit 201 inputs the encoded data of the decoding target picture and stores the encoded data in the encoded data memory 202 (step S51). In parallel to this, the reference camera picture input unit 203 inputs a reference picture and stores the reference picture in the reference camera picture memory 204. Further, the reference camera depth map input unit 205 inputs the reference camera depth map and outputs the reference camera depth map to the depth map conversion unit 206 (step S52).

Then, the depth map conversion unit 206 generates a virtual depth map from the reference camera depth map and stores the virtual depth map in the virtual depth map memory 207 (step S53). Also, the view-synthesized picture generation unit 208 applies 0 to the variable blk (step S56).

Then, the view-synthesized picture generation unit 208 generates a view-synthesized picture for the block blk from the reference camera picture and the virtual depth map and outputs the view-synthesized picture to the picture decoding unit 209 (step S54a). Subsequently, the picture decoding unit 209 decodes the decoding target picture for the block blk from the encoded data while using the view-synthesized picture as a predictive picture and outputs the resultant picture (step S55a). Also, the view-synthesized picture generation unit 208 increments the variable blk (blk←blk+1; step S57), and determines whether blk<numBlks is satisfied (step S58). If it is determined that blk<numBlks is satisfied, the process returns to step S54a in which the process is repeated, and ends the process at a time point at which blk=numBlks is satisfied.

Thus, when the depth map for the processing target frame is generated from the depth map for the reference frame, both of generation of the view-synthesized picture for only a specified region and generation of a high-quality view-synthesized picture can be realized, and efficient and lightweight picture encoding of the multiview picture can be realized by considering the quality of the view-synthesized picture generated in the occlusion region OCC rather than the geometric constraints in the real space. Accordingly, when the view-synthesized picture of the processing target frame (the encoding target frame or the decoding target frame) is generated using the depth map for the reference frame, both of high encoding efficiency and reduction of a memory capacity and a calculation amount can be realized by generating the view-synthesized picture for each block without reducing the quality of the view-synthesized picture.

While the process of encoding and decoding all the pixels in one frame has been described in the above description, the present invention may be applied to only some pixels, and encoding or decoding may be performed on other pixels using intra prediction coding, motion-compensated predictive coding or the like that is used in H.264/AVC or the like. In that case, it is necessary to encode or decode information indicating a method used to perform prediction on each pixel. Further, encoding or decoding may be performed using a different prediction scheme on each block rather than each pixel. Further, when the prediction using the view-synthesized picture is performed only on some pixels or blocks, a calculation amount of the view-synthesizing process can be reduced by performing a process (steps S4, S7, S54 and S54a) of generating a view-synthesized picture only on the pixels.

Further, while the process of encoding and decoding one frame has been described in the above description, the present invention can be applied to moving picture encoding through repetition of a plurality of frames. Further, the present invention can be applied to only some frames or some blocks of the moving picture. Further, while the configuration and the processing operation of the picture encoding apparatus and the picture decoding apparatus have been described in the above description, the picture encoding method and the picture decoding method of the present invention can be realized through a processing operation corresponding to an operation of each unit of the picture encoding apparatus and picture decoding apparatus.

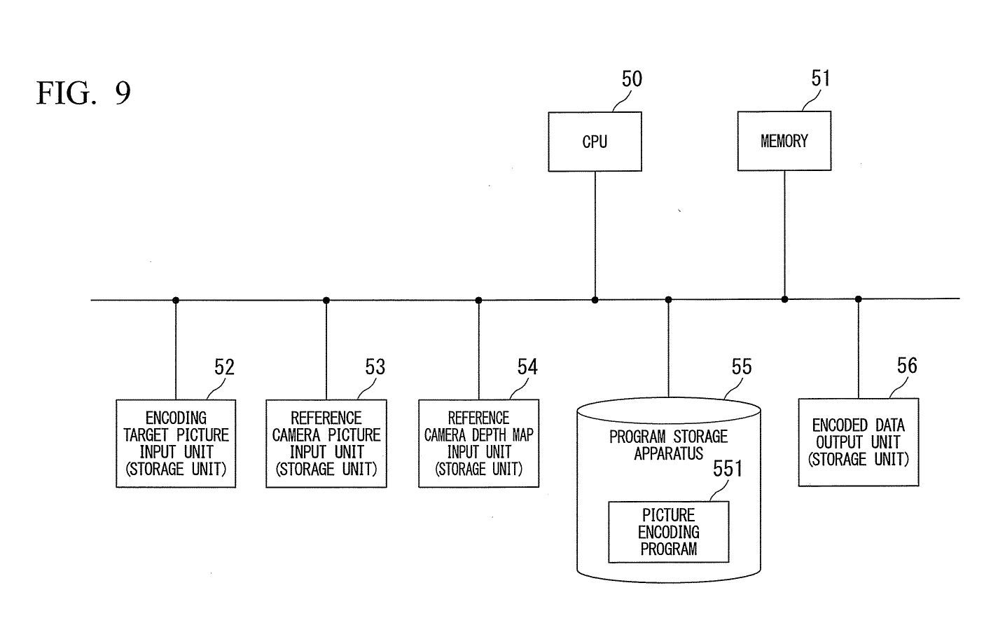

FIG. 9 is a block diagram showing a hardware configuration when the above-described picture encoding apparatus includes a computer and a software program. The system shown in FIG. 9 has a configuration in which a CPU 50, a Memory 51 such as a RAM, an encoding target picture input unit 52, a reference camera picture input unit 53, a reference camera depth map input unit 54, a program storage apparatus 55, and a multiplexed encoded data output unit 56 are connected by a bus.

The CPU 50 executes a program. The memory 51 such as a RAM stores a program or data accessed by the CPU 50. The encoding target picture input unit 52 (which may be a storage unit that stores an picture signal from a disc drive or the like) inputs an picture signal of an encoding target from a camera or the like. The reference camera picture input unit 53 (which may be a storage unit that stores an picture signal from a disc drive or the like) inputs an picture signal of a reference target from a camera or the like. The reference camera depth map input unit 54 (which may be a storage unit that stores a depth map from the disc drive or the like) inputs a depth map for a camera in a different position or direction from a camera capturing an encoding target picture from a depth camera or the like. The program storage apparatus 55 stores an picture encoding program 551 that is a software program that causes the CPU 50 to execute an picture encoding process described as the first embodiment. The multiplexed encoded data output unit 56 (which may be a storage unit that stores multiplexed encoded data from a disc drive or the like) outputs encoded data generated when the CPU 50 executes the picture encoding program 551 loaded in the memory 51, for example, over a network.

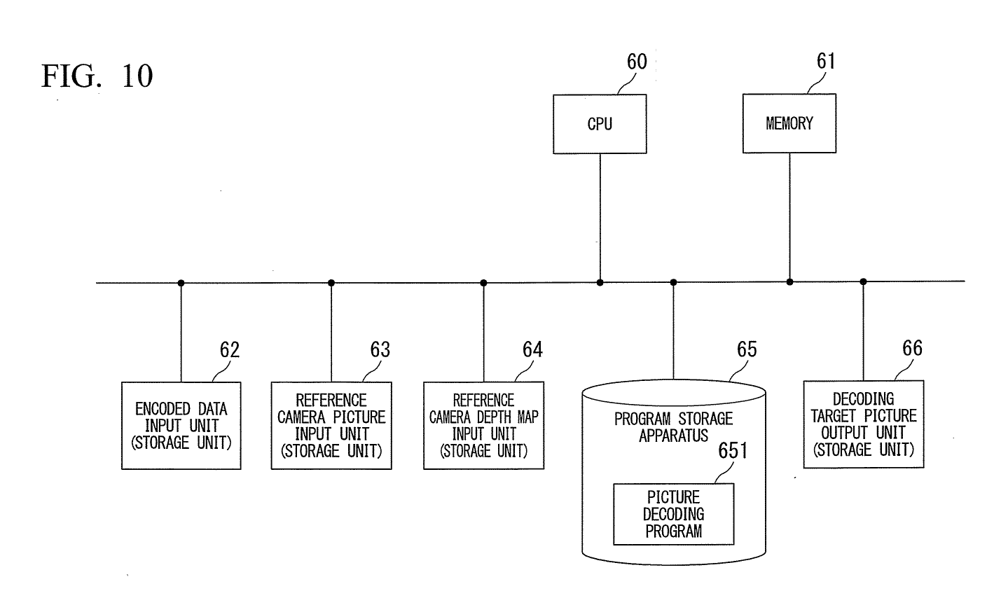

FIG. 10 is a block diagram showing a hardware configuration when the above-described picture decoding apparatus includes a computer and a software program. The system shown in FIG. 10 includes a CPU 60, a memory 51 such as a RAM, an encoded data input unit 62, a reference camera picture input unit 63, a reference camera depth map input unit 64, a program storage apparatus 65, and a decoding target picture output unit 66 are connected by a bus.

The CPU 60 executes a program. The memory 51 such as a RAM stores a program and data accessed by the CPU 60. The encoded data input unit 62 (which may be a storage unit that stores an picture signal from a disc drive or the like) inputs encoded data obtained when the picture encoding apparatus performs encoding using this scheme. The reference camera picture input unit 63 (which may be a storage unit that stores an picture signal from the disc drive or the like) inputs an picture signal of the reference target from a camera or the like. The reference camera depth map input unit 64 (which may be a storage unit that stores depth information from a disc drive or the like) inputs a depth map for a camera in a different position or direction from a camera that photographs a decoding target from a depth camera or the like. The program storage apparatus 65 stores an picture decoding program 651 that is a software program that causes the CPU 60 to execute an picture decoding process described as a second embodiment. The decoding target picture output unit 66 (which may be a storage unit that stores the picture signal from the disc drive or the like) outputs the decoding target picture obtained when the CPU 60 executes the picture decoding program 651 loaded in the memory 61 and decodes the encoded data, to a reproduction device or the like.

Further, the picture encoding process and the picture decoding process may be performed by recording a program for realizing the functions of the respective processing units in the picture encoding apparatus shown in FIG. 1 and the picture decoding apparatus shown in FIG. 6 in a computer-readable recording medium, loading the program recorded in the recording medium to a computer system, and executing the program. Further, “the computer system” referred to herein includes an OS or hardware such as a peripheral device. Further, the “computer system” also includes a WWW system including a homepage providing environment (or display environment). Further, the “computer-readable recording medium” includes a flexible disk, a magnetic optical disc, a ROM, a portable medium such as a CD-ROM, or a storage device such as a hard disk built in the computer system. Further, the “computer-readable recording medium” also includes a recording medium that holds a program for a certain time, such as a volatile memory (RAM) inside a computer system including a server and a client when a program is transmitted via a network such as the Internet or a communication line such as a telephone line.

Further, the above-described program may be transmitted from a computer system in which the program is stored in a storage device or the like to other computer systems via a transmission medium or by transmission waves in the transmission medium. Here, the “transmission medium” for transmitting the program refers to a medium having a function of transmitting information, such as a network (communication network) such as the Internet or a communication line such as a telephone line. Also, the above-described program may be a program for realizing some of the above-described functions. Alternatively, the program may be a program capable of realizing the above-described functions in combination with a program previously stored in a computer system, i.e., a differential file (a differential program).

While the embodiments of the present invention have been described above with reference to the drawings, it should be understood that the embodiments are only examples of the present invention and the present invention is not limited to the embodiments. Additions, omissions, substitutions, and other modifications of the components may be performed without departing from the spirit or scope of the present invention.

### INDUSTRIAL APPLICABILITY

The present invention is applicable to a use in which high encoding efficiency should be achieved with a small calculation amount when disparity compensation prediction is performed on the encoding (decoding) target picture using the depth map representing the three-dimensional position of the object for the reference frame.

### DESCRIPTION OF REFERENCE SIGNS

100: Picture Encoding Apparatus
101: Encoding Target Picture Input Unit
102: Encoding Target Picture Memory
103: Reference Camera Picture Input Unit
104: Reference Camera Picture Memory
105: Reference Camera Depth Map Input Unit
106: Depth Map Conversion Unit
107: Virtual Depth Map Memory
108: View-Synthesized Picture Generation Unit
109: Picture Encoding Unit
200: Picture Decoding Apparatus
201: Encoded Data Input Unit
202: Encoded Data Memory
203: Reference Camera Picture Input Unit
204: Reference Camera Picture Memory
205: Reference Camera Depth Map Input Unit
206: Depth Map Conversion Unit
207: Virtual Depth Map Memory
208: View-Synthesized Picture Generation Unit
209: Picture Decoding Unit

1. A picture encoding method for performing encoding a multiview picture which includes pictures for a plurality of views while predicting a picture between the views using an encoded reference picture for a view different from a view of an encoding target picture and a reference depth map that is a depth map of an object in the reference picture, the method comprising:
a depth map conversion step of converting the reference depth map into a virtual depth map that is a depth map of the object in the encoding target picture;
an occlusion region depth generation step of generating a depth value of an occlusion region in which there is no depth value assigned in the reference depth map generated by an anteroposterior relationship of the object by assigning a depth value of which a correspondence relationship with a region on the same object as the object shielded in the reference picture is obtained to the occlusion region; and
an inter-view picture prediction step of performing picture prediction between the views by generating a disparity-compensated picture for the encoding target picture from the virtual depth map and the reference picture after the depth value of the occlusion region is generated.

2. The picture encoding method according to claim 1,
wherein the occlusion region depth generation step includes generating the depth value of the occlusion region on an assumption of continuity of an object shielding the occlusion region on the reference depth map.

3. The picture encoding method according to claim 1, further comprising:
an occlusion generation pixel border determination step of determining a pixel border on the reference depth map corresponding to the occlusion region,
wherein the occlusion region depth generation step includes generating the depth value of the occlusion region by converting a depth of an assumed object into a depth on the encoding target picture on an assumption that an object continuously exists from the same depth value as a depth value of a pixel having a depth value indicating proximity to the view to the same depth value as a depth value of a pixel having a depth value indicating distance from the view in a position of the pixel having a depth value indicating proximity to the view on the reference depth map for each set of pixels of the reference depth map adjacent to the occlusion generation pixel border.

4. The picture encoding method according to claim 1, further comprising:
an object region determination step of determining an object region on the virtual depth map for a region shielding the occlusion region on the reference depth map; and
an object region extension step of extending a pixel in a direction of the occlusion region in the object region,
wherein the occlusion region depth generation step includes generating the depth value of the occlusion region by smoothly interpolating the depth value between a pixel generated through the extension and a pixel adjacent to the occlusion region and present in an opposite direction from the object region.

5. The picture encoding method according to claim 1,
wherein the depth map conversion step includes obtaining a corresponding pixel on the virtual depth map for each reference pixel of the reference depth map and performing conversion to a virtual depth map by assigning a depth indicating the same three-dimensional position as the depth for the reference pixel to the corresponding pixel.

6. A picture decoding method for performing decoding a decoding target picture of a multiview picture while predicting a picture between views using a decoded reference picture and a reference depth map that is a depth map of an object in the reference picture, the method comprising:
a depth map conversion step of converting the reference depth map into a virtual depth map that is a depth map of the object in the decoding target picture;
an occlusion region depth generation step of generating a depth value of an occlusion region in which there is no depth value assigned in the reference depth map generated by an anteroposterior relationship of the object by assigning a depth value of which a correspondence relationship with a region on the same object as the object shielded in the reference picture is obtained to the occlusion region; and
an inter-view picture prediction step of performing picture prediction between the views by generating a disparity-compensated picture for the decoding target picture from the virtual depth map and the reference picture after the depth value of the occlusion region is generated.

7. The picture decoding method according to claim 6,
wherein the occlusion region depth generation step includes generating the depth value of the occlusion region on an assumption of continuity of an object shielding the occlusion region on the reference depth map.

8. The picture decoding method according to claim 6, further comprising:
an occlusion generation pixel border determination step of determining a pixel border on the reference depth map corresponding to the occlusion region,
wherein the occlusion region depth generation step includes generating the depth value of the occlusion region by converting a depth of an assumed object into a depth on the encoding target picture on an assumption that an object continuously exists from the same depth value as a depth value of a pixel having a depth value indicating proximity to the view to the same depth value as a depth value of a pixel having a depth value indicating distance from the view in a position of the pixel having a depth value indicating proximity to the view on the reference depth map for each set of pixels of the reference depth map adjacent to the occlusion generation pixel border.

9. The picture decoding method according to claim 6, further comprising:
an object region determination step of determining an object region on the virtual depth map for a region shielding the occlusion region on the reference depth map; and
an object region extension step of extending a pixel in a direction of the occlusion region in the object region,
wherein the occlusion region depth generation step includes generating the depth value of the occlusion region by smoothly interpolating the depth value between a pixel generated through the extension and a pixel adjacent to the occlusion region and present in an opposite direction from the object region.

10. The picture decoding method according to claim 6,
wherein the depth map conversion step includes obtaining a corresponding pixel on the virtual depth map for each reference pixel of the reference depth map and performing conversion to a virtual depth map by assigning a depth indicating the same three-dimensional position as the depth for the reference pixel to the corresponding pixel.

11. A picture encoding apparatus for performing encoding a multiview picture which includes pictures for a plurality of views while predicting a picture between the views using an encoded reference picture for a view different from a view of an encoding target picture and a reference depth map that is a depth map of an object in the reference picture, the apparatus comprising:
a depth map conversion unit that converts the reference depth map into a virtual depth map that is a depth map of the object in the encoding target picture;
an occlusion region depth generation unit that generates a depth value of an occlusion region in which there is no depth value assigned in the reference depth map generated by an anteroposterior relationship of the object by assigning a depth value of which a correspondence relationship with a region on the same object as the object shielded in the reference picture is obtained to the occlusion region; and
an inter-view picture prediction unit that performs picture prediction between the views by generating a disparity-compensated picture for the encoding target picture from the virtual depth map and the reference picture after the depth value of the occlusion region is generated.

12. The picture encoding apparatus according to claim 11,
wherein the occlusion region depth generation unit generates the depth value of the occlusion region by assuming continuity of the object shielding the occlusion region on the reference depth map.

13. A picture decoding apparatus for performing decoding a decoding target picture of a multiview picture while predicting an picture between views using a decoded reference picture and a reference depth map that is a depth map of an object in the reference picture, the apparatus comprising:
a depth map conversion unit that converts the reference depth map into a virtual depth map that is depth map of the object in the decoding target picture;
an occlusion region depth generation unit that generates a depth value of an occlusion region in which there is no depth value assigned in the reference depth map generated by an anteroposterior relationship of the object by assigning a depth value of which a correspondence relationship with a region on the same object as the object shielded in the reference picture is obtained to the occlusion region; and
an inter-view picture prediction unit that performs picture prediction between views by generating a disparity-compensated picture for the decoding target picture from the virtual depth map and the reference picture after the depth value of the occlusion region is generated.

14. The picture decoding apparatus according to claim 13,
wherein the occlusion region depth generation unit generates the depth value of the occlusion region by assuming continuity of the object shielding the occlusion region on the reference depth map.

15. A non-transitory computer-readable recording medium storing a picture encoding program that causes a computer to execute the picture encoding method according to claim 1.

16. A non-transitory computer-readable recording medium storing a picture decoding program that causes a computer to execute the picture decoding method according to claim 6.

17. (canceled)

18. (canceled)
